(19) United States
(12) Patent Application Publication
(10) Pub. No.: US 2024/0111229 A1
(43) Pub. Date: Apr. 4, 2024

(54) IMAGE FORMING METHOD AND IMAGE FORMING APPARATUS

(71) Applicant: Konica Minolta, Inc., Tokyo (JP)

(72) Inventors: Ito KOGA, Tokyo (JP); Toru Hayase, Tokyo (JP)

(21) Appl. No.: 18/462,675

(22) Filed: Sep. 7, 2023

(30) Foreign Application Priority Data
Sep. 30, 2022 (JP) 2022-158264

(51) Int. Cl. G03G 15/16

(52) U.S. Cl. CPC G03G 15/162; G03G 15/161; G03G 2215/1623

(57) ABSTRACT

A toner image is formed on an intermediate transfer belt using a toner containing a crystalline polyester, and a recording material is interposed between the intermediate transfer belt and a secondary transfer roller having a first layer serving as a surface layer, a second layer formed of a solid layer provided on an inner peripheral side of the first layer, and a third layer formed of a porous elastic layer provided on an inner peripheral side of the second layer, and the toner image is transferred onto the recording material by the secondary transfer roller.

### CROSS REFERENCES TO RELATED APPLICATIONS

The entire disclosure of Japanese Patent Application No. 2022-158264, filed on Sep. 30, 2022, is incorporated herein by reference in its entirety.

### BACKGROUND

### Technological Field

The present invention relates to an image forming method and an image forming apparatus.

### Description of the Related Arts

In production printing, an increase in the speed of image formation by a copying machine, a printer, or the like, and an increase in the number of corresponding recording materials have been demanded. For example, an increase in the speed of image formation is achieved by reducing the time required for a recording material to pass through a fixing section. Therefore, it is required to fix the toner image in a short time.

In addition, a recording material having an uneven surface, such as embossed sheet or rough sheet, is used due to increased number of corresponding recording materials. Such a recording material having an uneven surface is less likely to be applied with a nip pressure when the toner image is fixed onto the recording material, and fixing property tends to decrease. In particular, a recording material provided with no gap, such as continuous sheet, tends to have a low temperature because the heat of the fixing roller is continuously consumed by the recording material, and therefore the fixing property tends to be lowered.

As a measure against such a decline in fixing property, use of a toner using a crystalline polyester as a binder resin has been proposed (see, for example, Japanese Unexamined Patent Publication No. 2020-173307). By using a crystalline polyester as a binder resin of the toner, both of the low-temperature fixability and the heat resistance of the toner can be achieved, and even when a decrease in the temperature of a fixing roller or a decrease in a nip pressure occurs, the decrease in fixing properties can be suppressed.

### SUMMARY

However, a toner using a crystalline polyester has low charge holding property, and the image density at the time of transfer may decrease. In particular, in the case of a recording material such as continuous sheet, since a surplus toner on the surface of the charging member cannot be ejected through a gap between recording materials, it is difficult to maintain the chargeability of the toner. When the charge amount of the toner decreases, in transfer (secondary transfer) from the image bearing member to a recording material, the movement of the toner by an electric field is not sufficient, and image quality tends to deteriorate due to image defects and the like.

In order to solve the problem described above, the present invention provides an image forming method and an image forming apparatus capable of suppressing deterioration of image quality.

The image forming method of the present invention includes forming a toner image on an intermediate transfer belt using a toner containing a crystalline polyester. The image forming method according to the present invention uses a secondary transfer roller including a first layer as a surface layer, a second layer formed of a solid layer provided on an inner peripheral side of the first layer, and a third layer formed of a porous elastic layer provided on an inner peripheral side of the second layer. In the image forming method of the present invention, a recording material is nipped between the secondary transfer roller and the intermediate transfer belt, and the toner image is transferred onto the recording material by the secondary transfer roller.

The image forming apparatus of the present invention forms a toner image on an intermediate transfer belt, sandwiches a recording material between the intermediate transfer belt and a secondary transfer roller, and transfers the toner image onto the recording material by the secondary transfer roller, thereby forming an image. The secondary transfer roller includes a first layer serving as a surface layer, a second layer formed of a solid layer provided on the inner peripheral side of the first layer, and a third layer formed of a porous elastic layer provided on the inner peripheral side of the second layer.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram illustrating a schematic configuration of an image forming apparatus.

FIG. 2 is a block diagram illustrating a configuration example of the image forming apparatus.

### DETAILED DESCRIPTION OF EMBODIMENTS

Hereinafter, examples of embodiments of the image forming apparatus of the present invention will be described, but the present invention is not limited to the following examples.

### [Configuration of Image Forming Apparatus]

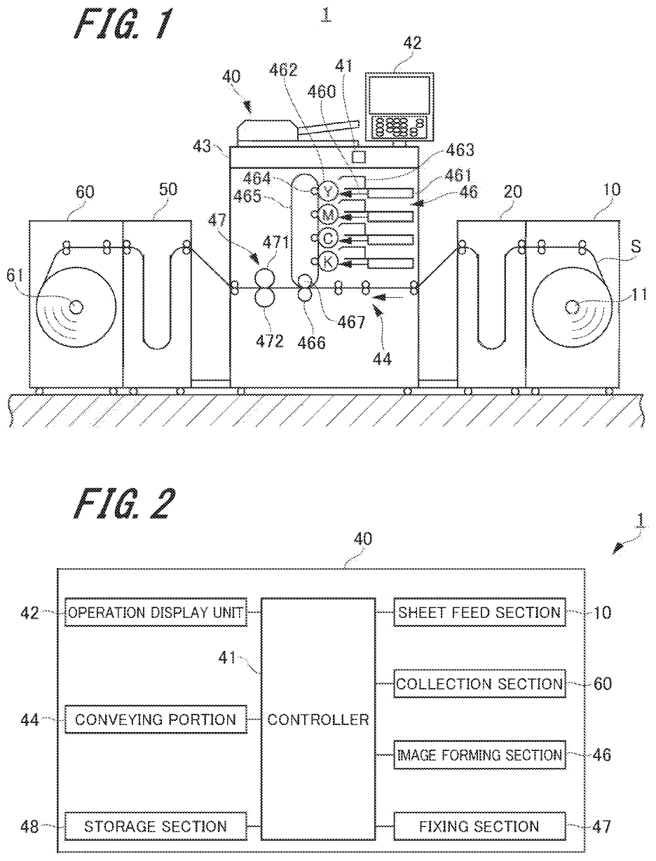

FIG. 1 illustrates and a schematic configuration of an image forming apparatus according to the present embodiment. An image forming apparatus 1 illustrated in FIG. 1 uses a roll of recording material S, which is continuous sheet, and forms an image on the recording material S. The image forming apparatus 1 includes a sheet feed section 10, an image forming apparatus main body 40, and a collection section 60 from the upstream side in the conveyance direction of the recording material S. The image forming apparatus 1 illustrated in FIG. 1 includes a supply adjustment section 20 between the sheet feed section 10 and the image forming apparatus main body 40, and includes a collection adjustment section 50 between the image forming apparatus main body 40 and the collection section 60.

The sheet feed section 10 includes a support shaft 11 that rotatably holds the recording material S in a state of being wound in a roll shape. The sheet feed section 10 conveys the recording material S wound around the support shaft 11 to the supply adjustment section 20 at a constant speed by a plurality of rollers. Note that the shape of the recording material S is not limited to a roll of continuous sheet. The recording material S may have any length as long as images of a plurality of pages can be continuously formed on the recording material S in the image forming apparatus main body 40. For example, a recording material having a foldable shape or a long sheet shape can be applied as the recording material S. The sheet feed section 10 is an example of a recording material supply device that supplies a recording material to the image forming apparatus body 40.

The supply adjustment section 20 conveys the recording material S conveyed from the sheet feed section 10 to an image forming section 46 of the image forming apparatus main body 40. In order to absorb the difference in speed between the sheet feeding and conveyance of the recording material S from the sheet feed section 10 and the conveyance of the recording material S in the image forming section 46, the supply adjustment section 20 holds the recording material S in a sagged state and adjusts the feeding of the recording material S to the image forming section 46.

The image forming apparatus body 40 includes a controller 41, an operation display unit 42, a scanner section 43, a conveying portion 44, the image forming section 46, and a fixing section 47. The image forming apparatus main body 40 may include the above-described sheet feed section 10 as a recording material supply section in the apparatus of the image forming apparatus main body 40.

The controller 41 integrally controls each configuration of the image forming apparatus 1 and the image forming apparatus main body 40. Furthermore, the controller 41 performs image processing on image data input from the scanner section 43 or the controller 41, and outputs the processed image data to the image forming section 46.

The operation display unit 42 is constituted by a display part constituted by a display such as a liquid crystal display device, and an operation part constituted by a touch screen, a plurality of keys, and the like provided to overlap the display. The display screen of the display is covered with a pressure-sensitive (resistive film pressure type) touch screen formed by arranging transparent electrodes in a lattice shape. The touch screen detects an XY coordinate of a force point pressed by a finger, a touch pen, or the like with a voltage value and outputs a detected position signal to the controller 41 as an operation signal. Further, the operation display unit 42 includes various operation buttons such as numeric buttons and a start button, and outputs an operation signal by a button operation to the controller 41.

The scanner section 43 performs exposure scanning of a document surface placed on a document plate with a light source, receives reflected light from the document surface, generates image data by photoelectrically converting the received reflected light with a charge coupled device (CCD), and outputs the image data to the controller 41.

The image forming section 46 forms an image on the recording material S transported from the supply adjustment section 20 by an electrophotographic method based on image data of each page input from the controller 41. The image forming section 46 includes a recording material conveyance path in which a conveyance belt, conveyance rollers such as a registration roller, and a motor (not illustrated) that drives these components are arranged. The image forming section 46 performs image formation on the recording material S while conveying the recording material S in accordance with the control from the controller 41.

The image forming section 46 includes four sets of exposure sections 461, photoreceptors 462, developing sections 463, primary transfer rollers 464, an intermediate transfer belt 465, a secondary transfer roller 466, and a counter roller 467, corresponding to respective color components of Y, M, C, and K. The four sets of exposure sections 461, photoreceptors 462, developing sections 463, and primary transfer rollers 464 corresponding to the respective color components are arranged in the order of Y, M, C, and K from the upstream side.

The exposure section 461 includes a laser light source, a polygon motor, a polygon mirror, and a plurality of lenses. The exposure section 461 irradiates and exposes the charged photoreceptor 462 with a laser light 460 by using a laser writing unit and a polygon mirror in accordance with the conveyance speed of the recording material, and forms an electrostatic latent image on the photoreceptor 462.

The developing section 463 supplies a toner of a predetermined color (Y, M, C, or K) onto the exposed photoreceptor 462 and develops the electrostatic latent image formed on the photoreceptor 462.

The primary transfer roller 464 is provided to face the photoreceptor 462. A primary transfer bias having a polarity opposite to that of the toner is applied to the primary transfer roller 464, and the primary transfer roller 464 presses a predetermined position on the intermediate transfer belt 465 against the photoreceptor 462 to transfer (primarily transfer) the toner image formed on the photoreceptor 462 to the intermediate transfer belt 465 by an electrostatic force. The primary transfer rollers 464 of Y, M, C, and K sequentially press predetermined positions of the intermediate transfer belt 465 against the photoreceptors 462, and thus a color toner image in which layers of the respective colors are superimposed is written onto the intermediate transfer belt 465.

The intermediate transfer belt 465 is a semiconductive endless belt suspended and rotatably supported by a plurality of rollers. The intermediate transfer belt 465 is rotationally driven along with rotation of the roller, and conveys the written toner image to the secondary transfer roller 466.

The secondary transfer roller 466 is applied with a bias having a polarity opposite to that of the toner, and nips and conveys the conveyed recording material S together with the intermediate transfer belt 465.

The counter roller 467 is disposed at a position opposed to the secondary transfer roller 466 via the intermediate transfer belt 465.

The intermediate transfer belt 465 on which the toner image is formed and the recording material S are nipped by the secondary transfer roller 466 and the counter roller 467, and the toner image formed on the intermediate transfer belt 465 is transferred (secondary transfer) to the recording material S by an electrostatic force.

In image forming apparatus main body 40, the controller 41 drives the intermediate transfer belt 465 at a linear velocity of 250 to 700 m per second (a linear velocity of 250 mm/s or more and 700 mm/s or less). By causing the controller 41 to drive the linear velocity of the intermediate transfer belt 465 in the above range, a decrease in productivity of the image forming apparatus 1 can be suppressed. Further, even in the case where the toner containing the crystalline polyester is used, by using the intermediate transfer belt 465 and the secondary transfer roller 466 having constitutions described later, the productivity and the image quality can be improved at the same time by driving the intermediate transfer belt 465 at the linear velocity described above by the controller 41.

The fixing section 47 heats and pressurizes the toner image transferred onto the recording material S to fix the toner image on the recording material S. The fixing section 47 includes a fixing roller 471 which includes a halogen heater and the like, and a pressure roller 472 which is arranged at a position opposite to the fixing roller 471 with a conveyance path of the recording material interposed therebetween and which serves as a pressure member for pressing the fixing roller 471. The fixing section 47 also includes a temperature sensor for detecting the temperature of the fixing roller 471. The fixing section 47 fixing the toner image by heating and pressurizing the toner image on the recording material S while pinching and conveying the recording material S on which the toner image is transferred in a nip part formed between the fixing roller 471 and the pressure roller 472.

Furthermore, the fixing section 47 includes a position change mechanism (not illustrated) that adjusts a position of the fixing roller 471 in order to, for example, adjust a nip pressure of a nip part between the fixing roller 471 and the pressure roller 472 and release the pressure contact.

The collection adjustment section 50 is installed on the downstream side of the image forming apparatus main body 40 and on the upstream side of the collection section 60 in the conveyance direction of the recording material S. The collection adjustment section 50 is a device that conveys the recording material S conveyed from the image forming apparatus main body 40 to the collection section 60. In order to absorb the difference of the speed between the conveyance of the recording material S in the image forming apparatus main body 40 and the conveyance of the recording material S in the collection section 60, the collection adjustment section 50 sags and holds the recording material S and adjusts the discharge of the recording material S from the image forming apparatus main body 40.

The collection section 60 includes a sheet ejection section that winds the recording material S conveyed from the collection adjustment section 50 by a support shaft 61 at a constant speed via a plurality of rollers.

### [Intermediate Transfer Belt]

Next, a configuration of the intermediate transfer belt 465 used in the image forming apparatus main body will be described.

The intermediate transfer belt 465 includes a base material layer, and a coating layer formed on a surface of the base material layer and made of an inorganic-organic hybrid material. In the intermediate transfer belt 465, the thickness of the coating layer made of the inorganic-organic hybrid material is preferably 10 μm or less. By providing the coating layer made of the inorganic-organic hybrid material, the intermediate transfer belt 465 can be constituted which is excellent in the transfer property with respect to the recording material S having the uneven shape on the surface.

### (Base Material Layer)

The base material layer is made of a material excellent in durability against external force such as tension and compression in order to avoid deformation of the belt due to stress applied during driving. The base material layer is formed so as to contain a resin which will be described later.

Resins constituting the base material layer are not particularly limited, and examples thereof include polyimide, polyamideimide, polycarbonate, polyvinylidene fluoride (PVDF), an ethylene-tetrafluoroethylene copolymer, polyamide and polyphenylene sulfide; and one kind may be selected from these resins and used alone, or a mixture containing two or more kinds may be used. Among these resins, at least one selected from the group consisting of polyimide, polyamideimide, and polyamide is preferable.

The base material layer preferably contains a conductive material in order to impart conductivity to the intermediate transfer belt 465. Examples of the conductive material include conductive metallic oxides such as carbon black; conductive carbon-based material such as graphite; metals and alloys such as aluminum and copper; conductive metal oxides such as tin oxide, zinc oxide, antimony oxide, indium oxide, potassium titanate, antimony oxide-tin oxide composite oxide (ATO), and indium oxide-tin oxide composite oxides (ITO). Among these conductive materials, one kind may be used alone, or two or more kinds may be used in combination. Among these conductive materials, conductive carbon-based materials are preferable; and carbon black is more preferable. The content ratio of the conductive material in the base material layer is not particularly limited, but for example, may be 5 to 30 mass %.

The base material layer can be formed by molding a composition for forming a base material layer containing a resin, a solvent, and an additive which is added as necessary into a desired belt shape.

The thickness of the base material layer is appropriately set in consideration of durability against stress and external force applied to the belt during driving. The thickness of the base material layers is, for example, 30 to 160 μm, preferably 30 to 120 μm, and more preferably 50 to 100 μm.

### (Coating Layer)

The toner is directly placed on the coating layer constituting the intermediate transfer belt 465 by primary transfer, and the coat layer releases the toner for transfer (secondary transfer) to the recording material S. For this reason, the intermediate transfer belt 465 has a coating layer on the surface of the base material layer on the side in contact with the toner.

The coating layer contains an inorganic-organic hybrid material. The coating layer containing the inorganic-organic hybrid material has high hardness and conductivity. Therefore, since the intermediate transfer belt 465 has the coating layer containing the inorganic-organic hybrid material, local conductivity and hardness with the base material layer are made uniform, and transferability to a recording material having unevenness on the surface is easily improved. In addition, the coating layer containing the inorganic-organic hybrid material is likely to improve the durability of the intermediate transfer belt 465.

In the intermediate transfer belt 465, the coating layer has a thickness of preferably 10 μm or less. When the thickness of the coating layer is 10 μm or less, the hardness and the conductivity due to the inorganic-organic hybrid material are easily exhibited. The thickness of the coating layer is preferably 1 to 10 μm and more preferably 1 to 6.5 μm from the viewpoint of more excellent durability of the intermediate transfer belt 465.

### (Inorganic-Organic Hybrid Material)

The coating layer is configured to contain an inorganic-organic hybrid material. Since the coating layer contains the inorganic-organic hybrid material, the influence on the conductivity of the base material layer is small, and thus the conductivity required as a transfer member can be appropriately maintained.

The coating layer preferably contains an inorganic-organic hybrid material formed by a sol-gel method. The sol-gel method is a method in which a sol liquid is applied to the surface of a base material layer, and then the sol liquid is subjected to a dehydration treatment (heating treatment) to be gelled, thereby forming a coating layer on the base material layer.

The inorganic-organic hybrid material forming the coating layers is preferably obtained by a reaction between an alkoxide of a metal or a metalloid as an inorganic component and an organosilicon compound or a fluorine-substituted organosilicon compound as an organic component.

Examples of the metal or metalloid that forms an alkoxide include metals and metalloids that can form an alkoxide, such as aluminum, silicon, titanium, vanadium, manganese, iron, cobalt, zinc, germanium, yttrium, zirconium, niobium, cadmium, and tantalum.

In addition, the kind of the alkoxide is not particularly limited, and examples thereof include methoxide, ethoxide, propoxide, butoxide, and the like. Furthermore, the alkoxide may be an alkoxide derivative in which a part of alkoxy groups is substituted with β-diketone, β-ketoester, alkanolamine, alkylalkanolamine or the like.

As the organosilicon compound, for example, a dialkyldialkoxysilane, a terminal silanol polydimethylsiloxane, or the like can be used.

The silanol-terminated polydimethylsiloxane preferably has a molecular weight of 400 to 10000.

In addition, examples of the fluorine-substituted organosilicon compound include compounds in which hydrogen in an organosilicon compound is substituted with fluorine. Examples of such a compound include CF3CH2CH2-Si(OC2H 5)3 and the like.

### (Alkoxysilane)

In the intermediate transfer belt 465, the coating layer made of the inorganic-organic hybrid material preferably includes a cured product obtained by curing alkoxysilane. When the coating layer contains a cured product of alkoxysilane, the transferability of the toner image from the intermediate transfer belt 465 to the recording material S is improved.

As the alkoxysilane, for example, it is preferable to contain tetraalkoxysilane or trialkoxysilane, and dialkoxysilane or monoalkoxysilane. Furthermore, it is preferable that the alkoxysilane contains tetraalkoxysilane or trialkoxysilane in a range of 80 to 90 mass % and monoalkoxysilane or dialkoxysilane in a range of 10 to 20 mass % with respect to the total alkoxysilane.

Examples of the monofunctional alkoxysilane (monoalkoxysilane) include trimethylmethoxysilane, triethylmethoxysilane, trimethylethoxysilane, and triethylethoxysilane.

Examples of the bifunctional alkoxysilane (dialkoxysilane) include dimethyldimethoxysilane, diethyldimethoxysilane, diisopropyldimethoxysilane, diisobutyldimethoxysilane, dimethyldiethoxysilane, and diethyldiethoxysilane.

Examples of the trifunctional alkoxysilane (trialkoxysilane) include methyltrimethoxysilane, ethyltrimethoxysilane, N-propyltrimethoxysilane, isopropyltrimethoxysilane, N-butyltrimethoxysilane, isobutyltrimethoxysilane, N-hexyltrimethoxysilane, N-octyltrimethoxysilane, N-decyltrimethoxysilane, N-dodecyltrimethoxysilane, N-tetradecyltrimethoxysilane, N-hexadecyltrimethoxysilane, N-octadecyltrimethoxysilane, methyltriethoxysilane, ethyltriethoxysilane, N-propyltriethoxysilane, isopropyltriethoxysilane, N-butyltriethoxysilane, isobutyltriethoxysilane, N-hexyltriethoxysilane, N-octyltriethoxysilane, N-decyltriethoxysilane, N-dodecyltriethoxysilane, N-tetradecyltriethoxysilane, N-hexadecyltriethoxysilane, and N-octadecyltriethoxysilane.

Examples of the tetrafunctional alkoxysilane (tetraalkoxysilane) include tetramethoxysilane, tetraethoxysilane, tetra-n-propoxysilane, tetra-isopropoxysilane, and tetraphenoxysilane.

### (Method of Forming Coating Layer)

For the formation of the coating layers, first, a hydrolysis product of alkoxides of metals or metalloids is reacted with organic components, such as an organosilicon compound and a fluorine-substituted organosilicon compound, to prepare a sol liquid. The organic components may be blended with the alkoxides before hydrolysis, or may be blended with the alkoxides after hydrolysis.

The solvent used at this time is not particularly limited as long as the solvent can uniformly disperse and dissolve the alkoxide and the organic component, and examples thereof include acetone, toluene, and xylene, in addition to various alcohols such as methanol and ethanol. Note that in order to accelerate the hydrolysis reaction of the alkoxides, a catalyst such as hydrochloric, phosphoric, or acetic acids may be appropriately used.

In a case where the terminal silanol polydimethylsiloxane is reacted with an alkoxide, an alkoxy group of the alkoxide is substituted with a hydroxyl group, and the hydroxyl group causes a dehydration/condensation reaction with a silanol group at a terminal of the terminal silanol polydimethylsiloxane to form an elastomer.

In the sol liquid obtained as described above, the adhesion to the base material layer can be improved by sufficiently hydrolysis the alkoxides by stirring or the like and performing partial dehydration-polymerization.

After the surface of the base material layer is coated with the sol liquid, the coated sol liquid is dehydrated and dried to form a coating layer.

As a method of applying the obtained sol liquid to the surface of the base material layer, a known method can be used, and for example, a method such as dip coating, spray coating, roll coating, or flow coating can be used.

The dehydration and drying may be performed by natural drying, but is generally performed by heat treatment. The conditions of the heat treatment are not particularly limited as long as a coating layer can be formed, and the conditions are usually set at 60 to 450° C. for 20 seconds to 7 hours. The coating step may be performed not only once but also a plurality of times. in other words, the coating layer may be formed of a single coating or a plurality of coating.

As the sol liquid of the inorganic-organic hybrid material forming the coating layer, a commercially available product can be used. Examples of a commercially available product of the inorganic-organic hybrid material include product names HB11B, HB21BN, HB31BN, and X11008 manufactured by Nittobo Medical Co., Ltd.

### [Secondary Transfer Roller]

Next, a configuration of the secondary transfer roller 466 used in the image forming apparatus main body 40 will be described. The secondary transfer roller 466 includes a surface layer (first layer), a solid layer (second layer) provided on an inner peripheral side of the surface layer, and a porous elastic layer (third layer) provided on an inner peripheral side of the solid layer.

In the secondary transfer roller 466, for example, a core metal serving as a shaft body of the secondary transfer roller 466 is press-fitted to porous elastic layer (third layer), and a tube-shaped solid layer (second layer) having elasticity is fitted on the surface of the porous elastic layer (third layer). Then, the surface layer (first layer) is coated and solidified on the outer periphery of the solid layer (second layer).

Since the secondary transfer roller 466 has the above-described three-layers structure, a large number of porous cells formed in the porous elastic layer are easily deformed, and can abut against the recording material S and the intermediate transfer belt 465 in a state in which the nip pressure is substantially uniform in the axial direction. As a result, a satisfactory image without density unevenness can be formed.

Further, in the secondary transfer roller 466, by providing a solid layer which is a non-foamed elastic layer and an insulating layer which is a thin film and has a high resistance as a surface layer on the outer periphery of the porous elastic layer, the surface of the secondary transfer roller 466 becomes smooth, so that the electric field is liable to be uniformly applied to the recording material S. As a result, even with respect to the toner containing the crystalline polyester and having the low charge holding property under the low temperature and low humidity, the electric field is easily applied to the toner by ensuring the nip pressure, so that the toner is easily moved from the intermediate transfer belt 465 onto the recording material S. For this reason, the mobility of the toner from the intermediate transfer belt 465 to the recording material S by the electric field during the secondary transfer can be sufficiently ensured, so that the lowering in image quality due to the generation of the image defect such as the image noise can be suppressed.

### (Porous Elastic Layer)

The porous elastic layer is formed of a foamed rubber having adhesiveness, a conductive rubber obtained by adding a conductive material to non-adhesive foamed rubber, a semiconductive rubber, or the like.

For example, the porous elastic layer is formed by foaming a foaming material by heating. This foamed material is obtained by mixing a foaming agent or the like with a main agent. Examples of the main agent include an ethylene-propylene-diene rubber (EPDM), a styrene-butadiene rubber (SBR), an acrylonitrile-butadiene rubber (NBR), a hydrin rubber, an isoprene rubber, a silicone rubber, and the like. Examples of the foaming agent include dinitrosopentamethylenetetramine (PPT), P,P′-oxybisbenzenesulfonyl hydrazide (OBSH), and azodicarbonamide (ADCA). The foaming agent is mixed in an amount of 1 to 20 parts by mass per 100 parts by mass of the main agent.

Furthermore, in the porous elastic layer, with respect to 100 parts by mass of the main agent, 1 to 100 parts by mass of a conductive material such as carbon black or quaternary ammonium for ensuring conductivity and to 100 parts by mass of a plasticizer such as paraffin oil or naphthene oil for ensuring foamability may be added.

Although not particularly limited, 0.3 to 5 parts by mass of a crosslinking agent such as sulfur, 1 to 10 parts by mass of a crosslinking aid such as zinc oxide, and 0.5 to 3 parts by mass of a crosslinking accelerator such as thiazoles, dithiocarbamates, and thiurams may be added to the main agent.

In addition, a viscosity imparting agent such as a phenol resin, a coumarone resin, an acetylene resin, or a terpene resin may be added.

Furthermore, in the main agent, various additives such as a lubricant, an inorganic filler, and a foam stabilizer may be appropriately blended as necessary.

The porous elastic layer is usually configured to have a thickness in a range of 2 to 8 mm.

The porous elastic layer can have a storage elastic modulus of 100000 Pa or more and 275000 Pa or less. The storage elastic modulus of the porous elastic layer is measured using dynamic mechanical analysis (DMA) based on the “Method for Testing Dynamic Properties of Vulcanized Rubber” specified in JIS K6394. The measurement conditions of the storage elastic modulus are, for example, a compression mode, a compression jig diameter of 08, a temperature of 20 to 80° C., a frequency of 6. 3 Hz, an initial load of 400 g, and a strain of 0. 1%.

When the storage elastic modulus of the porous elastic layer is within the above range, the porous elastic layer can be brought into contact with the intermediate transfer belt 465 via the recording material S while having a substantially uniform nip width in the axial direction. As a result, in the secondary transfer section, a satisfactory toner image with no density nonuniformity can be transferred from the intermediate transfer belt 465 to the recording material S.

### (Solid Layer)

The solid layer is formed to cover the porous elastic layer, and is composed of a solid elastic body which is not porous. The solid layer is made of, for example, an adhesive rubber, a conductive rubber obtained by adding a conductive material to non-adhesive rubber, or a semiconductive rubber. As the rubber, NBR (nitrile rubber), EPDM (ethylene-propylene rubber), hydrin rubber, urethane rubber, acrylic rubber, chloroprene rubber, and the like can be used. As the rubber having adhesiveness, a rubber obtained by adding a tackifier such as a phenol resin, a coumarone resin, an acetylene resin, or a terpene resin to NBR (nitrile rubber), EPDM (ethylene-propylene rubber), or the like can be used.

The solid layer may contain various additives, as required.

### (Surface Layer)

The surface layer is formed in order to improve cleanability of toner and recording material powder and to protect the solid layer. Examples of the surface layer include acrylic resins, urethane resins, alkyd resins, amide resins, phenolic resins, fluorocarbon resins, silicone resins, and modified resins thereof. The surface layer preferably contains a material obtained by appropriately adding a conductive material to a urethane resin containing a fluororesin. Furthermore, the surface layer may appropriately contain, as necessary, various additives such as a conductive material, a leveling agent, a crosslinking agent, and a releasability imparting agent.

The surface layer is formed by coating the outer periphery of the solid layer with a film having a thickness of 5 to 9 μm and curing the film by heating.

The outermost surface of the surface layer preferably has a resistance of 5×10¹⁰Ω/□ or more and 5×10¹³Ω/□ or less.

The resistance of the outermost layer of the secondary transfer roller 466 is measured using, as resistance measuring devices, a resistance meter Hirestaup MCP-HT450 (manufactured by Mitsubishi Chemical Analytech Co., Ltd) and electrodes of URS probe (manufactured by Mitsubishi Chemical Analytech Co., Ltd). The measurement conditions are a measurement atmospheric temperature of 23° C. and a relative humidity of 50%, a measurement mode of ρ s (surface resistivity), an application voltage of 1000 V, and an application time of 10 sec.

In the measurement, the tube of the solid layer of the secondary transfer roller 466 is cut along the axial direction, and the solid layer is placed on the metal surface side of a register table UFL attached to the Hirestaup so that the surface layer becomes the upper surface. Then, in the central portion in the width direction, five points at equal intervals in the axial direction are measured using the electrode, and the average value thereof is obtained and defined as the outermost surface resistance. The load at the time of measurement is 2.0 kgf (19.6 N).

### (Shaft Body)

The shaft body of the secondary transfer roller 466 is not particularly limited, and may be solid or hollow. The material for forming the shaft body is not particularly limited, and examples thereof include iron, plated iron, stainless steel, aluminum, and copper. An adhesive, a primer, or the like is usually applied to the surface of the shaft body. Furthermore, the shaft body is usually configured within a range of outer diameter 4 to 15 mm and within a range of 230 to 500 mm.

### [Counter Roller]

Next, the configuration of the counter roller 467 used in the image forming apparatus 40 will be described. The counter roller 467 includes a cored bar made of a conductive material, which is a shaft body, and a conductive elastic layer that covers a circumferential surface of the cored bar. The elastic layer includes, for example, a rubber layer made of a single solid rubber such as nitrile rubber (NBR) or a single foamed rubber, a porous elastic layer (sponge layer), and a porous elastic layer with a rubber layer on its surface.

The surface of the counter roller 467 may be coated with a low-friction material. Examples of the low-friction material include ethylene tetrafluoride resin, melamine resin, nylon, polyethylene, urea resin, polyacetal, ABS resin, vinyl chloride resin, polypropylene, phenol resin, polycarbonate, polystyrene, acrylic resin, and epoxy resin.

The counter roller 467 has a surface hardness of, for example, preferably 65° or greater. The hardness of the counter roller is measured by using a Durometer ASKER Rubber Hardness Tester Type C manufactured by ASKER K. K. and adjusting the total load to be 1 kg. In the measurement of the hardness, five points are taken at equal intervals in the axial longitudinal direction of the counter roller 467, and the hardness is measured at a total of points of four points each obtained by rotating each of the five points by 90° in the circumferential direction. Then, an average value of the measured values at the measured 20 points is defined as the hardness of the counter roller.

### [Electrostatic Charge Image Developing Toner]

The above-described image forming apparatus main body 40 is suitable for image formation using an electrostatic charge image developing toner (hereinafter, also simply referred to as a toner) containing a crystalline polyester. By containing the crystalline polyester, a sharp melting property of rapidly melting at a predetermined temperature can be imparted to the toner, and both the low-temperature fixability and the heat-resistant storage property of the toner can be achieved. Therefore, in the image forming apparatus 1, it is possible to suppress a decrease in fixability even when the temperature of the fixing section 47 decreases or the nip pressure decreases.

Further, by providing the intermediate transfer belt 465, the secondary transfer roller 466, and the counter roller 467 with the above-described configuration, it is possible to suppress a decrease in image density at the time of transfer due to a decrease in charge holding property of the toner containing the crystalline polyester, and thus it is suitable for suppressing a decrease in image quality.

The toner is used for development of an electrostatic charge image (electrostatic latent image) formed on an image bearing member such as a photoreceptor. The toner may be a one-component developer, or may be a two-components developer including carrier particles and toner particles. The toner base particles to which an external additive is added are referred to as toner particles, and an aggregate of the toner particles is referred to as a toner. In general, the toner base particles can be used as they are as toner particles; however, it is preferable that the toner base particles are used as toner particles obtained by adding an external additive to the toner base particles.

The toner base particles contain a toner base particle precursor containing a binder resin, and other components such as a pigment, a release agent, and a charge control agent. it is preferable that the binder resin contains an amorphous resin and a crystalline resin, and the crystalline resin contains a crystalline polyester.

### (1. Toner Base Particles)

The toner base particles preferably have a volume-based average particle size of 5.0 μm or more and 8.0 μm or less, and more preferably 5.5 μm or more and 7.0 μm or less. When the volume-based average particle diameter of the toner base particles is 5.0 μm or more, two or more kinds of pigments can be sufficiently internally added to the toner base particles to obtain good color developability, and the transfer efficiency of the toner can be made high. When the volume-based average particle diameter of the toner base particles is 8.0 μm or less, the resolution of an image to be formed can be further improved.

The volume-based average particle size of the toner base particles can be measured using a measurement apparatus obtained by connecting a particle size distribution measuring device (Coulter Multisizer 3 manufactured by Beckman Coulter, Inc) to a computer system equipped with data-processing software Software V3.51. Specifically, a sample (toner base particles) 0.02 g is added to a surfactant solution 20 mL (e.g., a surfactant solution prepared by diluting a neutral detergent containing a surfactant component with pure water by a factor of 10 for the purpose of dispersing the toner particles) and allowed to acclimate, followed by ultrasonic dispersion treatment for 1 minute to prepare a dispersion liquid of the toner base particles. This dispersion liquid is poured into a beaker containing an electrolytic solution (ISOTONII, manufactured by Beckman Coulter, Inc) in a sample stand with a pipette until the concentration displayed on the measurement apparatus reaches 8%. With this concentration, a reproducible measurement value can be obtained. Then, in the measurement apparatus, the number of particles to be measured is set to 25000, the aperture diameter is set to 100 μm, the range of 2 to 60 μm which is the measurement range is divided into 256 to calculate the frequency value, and the volume-based average particle diameter is calculated based on the frequency value.

### (1-1. Binder Resin)

The binder resin constituting the toner base particles may be a thermoplastic resin. Examples of the thermoplastic resin include a styrene resin, a vinyl resin (an acrylic resin, a styrene acrylic resin, and the like), a polyester resin, a silicone resin, an olefin resin, a polyamide resin, an epoxy resin, and the like. The binder resin may be either an amorphous resin or a crystalline resin.

Furthermore, the toner base particle preferably contains a crystalline polyester as a binder resin of the thermoplastic resin. The toner base particle preferably further contains an amorphous polyester and a styrene acrylic resin together with the crystalline polyester.

### (1-1-1. Crystalline Resin)

The crystalline resin refers to a resin having a melting point in an endothermic curve obtained by differential scanning calorimetry (DSC).

The endothermic curve can be measured with a known DSC measuring device (for example, diamond DSC manufactured by PerkinElmer Inc). To be specific, the measurement samples (resins) 3.0 mg are sealed in an aluminum pan, and the pan is set in a sample holder of a DSC measuring machine. An empty aluminum pan is used as a reference. Then, an endothermic curve is obtained under measurement conditions (heating and cooling conditions) including a first heating process of heating from 0° C. to 200° C. at a temperature rising rate of 10° C./min, a cooling process of cooling from 200° C. to 0° C. at a cooling rate of 10° C./min, and a second heating process of heating from 0° C. to 200° C. at a temperature rising rate of 10° C./min in this order.

Note that the melting point of the crystalline resin refers to a clear endothermic peak observed during temperature increase in an endothermic curve. The clear endothermic peak refers to, in an endothermic curve obtained by DSC measurement, a peak having a half value width of 15° C. or less in an endothermic curve when heated at a temperature rising rate of 10° C./min.

In addition, based on the endothermic curve obtained by the DSC measurement, an extension line of the baseline before the rising of the first endothermic peak in each heating process and a tangent line showing the maximum inclination between the rising portion of the first peak and the peak apex are drawn, and the intersection point thereof is defined as the glass transition temperature (Tg₁ and Tg₂).

The content of the crystalline resin is preferably 3% by mass or more and 30% by mass or less, more preferably 5% by mass or more and 20% by mass or less based on the total mass of the toner base particle. When the content of the amorphous resin is 3% by mass or more, the fixability of the toner can be further improved.

The toner base particle preferably contains a crystalline polyester resin as a binder resin. Examples of crystalline resins other than the crystalline polyester resin that can be used in the toner base particles include styrene resins, vinyl resins, olefin resins, epoxy resins, polyurethane resins, polyamide resins, cellulose resins, and polyether resins. These resins may be used alone or in combination of two or more kinds thereof.

When the toner base particles contain a crystalline polyester as a binder resin of the thermoplastic resin, the low-temperature fixability of the toner can be improved. The crystalline polyester resin may be any crystalline resin obtained by a polycondensation reaction of a divalent or higher valent carboxylic acid (polyvalent carboxylic acid) and a divalent or higher valent alcohol (polyhydric alcohol).

Examples of the polycarboxylic acids include, but are not limited to, divalent aliphatic dicarboxylic acids such as oxalic, succinic, glutaric, adipic, suberic, azelaic, sebacic, 1,9-nonanedicarboxylic, 1,10-decanedicarboxylic, dodecanedioic (1,12-dodecanedicarboxylic), 1,14-tetradecanedicarboxylic, and 1,18-octadecanedicathoxylic, and divalent aromatic dicarboxylic acids such as phthalic, isophthalic, terephthalic, naphthalene 2,6-dicarboxylic, malonic, and mesaconic acids. These may be an anhydride or a lower alkyl ester.

In addition, the polyvalent carboxylic acids may be 1,2,4-benzenetricarboxylic acid, 1,2,5-benzenetricarboxylic acid, 1,2,4-naphthalenetricarboxylic acid, anhydrides thereof, or carboxylic acids having three or more valences such as lower alkyl esters. Further, unsaturated polyvalent carboxylic acids including maleic acid, fumaric acid, 3-hexenedioic acid, 3-octenedioic acid and the like may be used.

The polyhydric alcohol is preferably an aliphatic diol, and more preferably a linear aliphatic diol having 7 or more and 20 or less carbon atoms in the main chain portion. In particular, a linear aliphatic diol tends to increase the crystallinity of the polyester resin and does not tend to decrease the melting temperature. Therefore, the linear aliphatic diol can further improve the anti-blocking property, the image storage stability, and the low-temperature fixability of the toner. At this time, when the number of carbon atoms of the linear aliphatic diol is 7 or more and 20 or less, the melting point at the time of polycondensation with the polyvalent carboxylic acid component can be further lowered, and the synthesis is easy.

The aliphatic diols can be, for example, ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, and 1,18-octadecanediol, and the like. In addition, as the aliphatic diol, alcohols having three or more hydroxyl groups including glycerin, trimethylolethane, trimethylolpropane, pentaerythritol, and the like may be used.

The mass average molecular weight of the crystalline polyester resin is preferably 5000 or more and 50000 or less. The mass average molecular weight of the crystalline polyester resin is a value measured by gel permeation chromatography (GPC). An example of the method of measuring the mass average molecular weight is shown below.

HLC 8120GPC (manufactured by Tosoh Corporation) as a measurement device and TSKguardcolumn+TSKgelSuperHZ-M3 series (manufactured by Tosoh Corporation) as a column are prepared. While the column temperature is maintained at 40° C., tetrahydrofuran (THF) as a carrier solvent is allowed to flow at a flow rate of 0.2 mL/min. Measurement samples (resins) are dissolved in tetrahydrofuran so as to have a concentration of 1 mg/ml. The solution is treated at room temperature for 5 minutes using an ultrasonic disperser, and then treated with a membrane filter having a pore size of 0.2 μm to give the intended product. 10 μL of the sample solution is injected into the device together with a carrier solvent, and detected using a refractive index detector (RI detector). Then, the molecular weight distribution of the measurement sample is calculated based on a calibration curve prepared using monodisperse polystyrene standard particles.

### (1-1-2. Amorphous Resin)

On the other hand, an amorphous resin refers to a resin for which, in an endothermic curve obtained by performing differential scanning calorimetry (DSC) in the same manner as described above, a baseline curve indicating that glass transition has occurred is seen, but the aforementioned clear endothermic peak is not seen.

When the glass transition temperature measured in the first heating process in the DSC measurement is defined as Tg₁ and the glass transition temperature measured in the second heating process is defined as Tg₂, the amorphous resin preferably has Tg₁ of 35° C. or more and 80° C. or less, more preferably 45° C. or more and 65° C. or less. Tg₂ of the amorphous resin is preferably 20° C. or more and 70° C. or less, more preferably 30° C. or more and 55° C. or less. When the Tg₁ of the amorphous resin is 35° C. or more, or the Tg₂ is 20° C. or more, the heat resistance (heat-resistant storage property and the like) of the toner can be further improved. When the amorphous resin has a Tg₁ of 80° C. or less or a Tg₂ of 70° C. or less, the low-temperature fixability of the toner can be further improved.

The content of the amorphous resin is preferably from 20% by mass to 99% by mass, more preferably from 30% by mass to 95% by mass, and even more preferably from 40% by mass to 90% by mass, with respect to the total weight of the toner base particles. When the content of the amorphous resin is 20% by mass or more, the strength of an image thus formed can be further improved.

The toner base particle preferably contains an amorphous polyester resin as a binder resin. Examples of amorphous resins other than the amorphous polyester resin that can be used in the toner base particles include styrene resins, vinyl resins, olefin resins, epoxy resins, polyurethane resins, polyamide resins, cellulose resins, and polyether resins. These resins may be used alone or in combination of two or more kinds thereof. The toner base particle preferably includes a vinyl resin such as a styrene acrylic resin in addition to the amorphous polyester resin.

The amorphous polyester resin can improve the low-temperature fixability of the toner. The amorphous polyester resin may be any amorphous resin obtained by a polycondensation reaction between a divalent or higher valent carboxylic acid (polyvalent carboxylic acid) and a divalent or higher valent alcohol (polyhydric alcohol).

Examples of the polyvalent carboxylic acid include unsaturated aliphatic polyvalent carboxylic acids, aromatic polyvalent carboxylic acids, and derivatives thereof. As long as the resulting polyester resin is amorphous, a saturated aliphatic polycarboxylic acid may be used in combination with the above polycarboxylic acid.

Examples of the polyhydric alcohol include unsaturated aliphatic polyhydric alcohols, aromatic polyhydric alcohols, and derivatives thereof. A saturated aliphatic polyhydric alcohol may be used in combination with the aforementioned polyhydric alcohol as long as the polyester resin to be obtained is amorphous. The polyvalent fatty acid and the polyhydric alcohol may be used alone or in combination of two or more thereof.

### (1-1-3. Vinyl Resin)

The vinyl resin firmly binds the toner base particles to suppress the embedding of the external additive in the toner base particles, and the effect of improving the chargeability by the external additive can be further enhanced. The vinyl resin is not particularly limited as long as it is obtained by polymerizing a vinyl compound, and examples thereof include a (meth) acrylic acid ester resin, a styrene-(meth)acrylic ester resin, and an ethylene-vinyl acetate resin. These may be used alone or in combination of two or more kinds thereof.

The content of the vinyl resin is preferably 0.1% by mass or more and 20% by mass or less based on the total mass of the binder resin. When the content of the vinyl resin is 0.1% by mass or more, the effect of suppressing embedment of the external additive is sufficiently exhibited. When the content of the vinyl resin is 20% by mass or less, the low-temperature fixability of the toner is easily enhanced by increasing the content of other resins (in particular, the amorphous polyester resin).

Among the vinyl resins, from the viewpoint of plasticity during heat fixing, a styrene-(meth)acrylic ester resin is preferable. Hereinafter, a styrene-(meth)acrylic ester resin (hereinafter, also referred to as a styrene-(meth)acrylic resin or simply a styrene acrylic resin) as an amorphous resin will be described.

The styrene-(meth)acrylic resin is formed by addition polymerization of at least an aromatic vinyl monomer and a (meth) acrylic acid ester monomer. The aromatic vinyl monomer includes, in addition to styrene represented by the structural formula of CH₂═CH—C₆H₅, those having a known side chain or functional group in the styrene structure. In addition, the (meth) acrylic acid ester monomer referred to herein includes those having a known side chain or functional group in the structure of an acrylic acid ester derivative or a methacrylic acid ester derivative, in addition to an acrylic acid ester or a methacrylic acid ester represented by CH₂═CHCOOR (R represents an alkyl group). Note that the term “(meth) acrylic acid ester monomer” collectively refers to an acrylic acid ester monomer and a methacrylic acid ester monomer.

Examples of the aromatic vinyl monomer and the (meth) acrylic acid ester monomer from which the styrene-(meth)acrylic resin can be formed are described below.

Examples of the aromatic vinyl monomer include, for example, styrene, o-methylstyrene, m-methylstyrene, p-methylstyrene, A-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, p-n-dodecylstyrene and the like. These aromatic vinyl monomers may be used alone, or two or more kinds thereof may be used in combination.

In addition, specific examples of the (meth) acrylic acid ester monomer include an acrylic acid ester monomer such as methyl acrylate, ethyl acrylate, isopropyl acrylate, N-butyl acrylate, t-butyl acrylate, isobutyl acrylate, N-octyl acrylate, 2-ethylhexyl acrylate, stearyl acrylate, lauryl acrylate, phenyl acrylate; and a methacrylic acid ester such as methyl methacrylate, ethyl methacrylate, N-butyl methacrylate, isopropyl methacrylate, isobutyl methacrylate, t-butyl methacrylate, N-octyl methacrylate, 2-ethylhexyl methacrylate, stearyl methacrylate, lauryl methacrylate, phenyl methacrylate, diethylaminoethyl methacrylate, dimethylaminoethyl methacrylate. These (meth) acrylic acid ester monomers may be used alone or in combination of two or more kinds thereof.

The content of the constituent unit derived from the aromatic vinyl monomer in the styrene-(meth)acrylic resin is, for example, preferably within a range of 40 to 90 mass % with respect to the total amount of the resin. In addition, the content of the constituent unit derived from the (meth) acrylic acid ester monomer in the resin is, for example, preferably in the range of 10 to 60 mass % with respect to the total amount of the resin.

Furthermore, the styrene-(meth)acrylic resin may contain the following monomer compounds in addition to the aromatic vinyl monomer and the (meth) acrylic acid ester monomer. For example, a compound having carboxy group such as acrylic acid, methacrylic acid, maleic acid, itaconic acid, cinnamic acid, fumaric acid, maleic acid monoalkyl ester, itaconic acid monoalkyl ester; a compound having a hydroxy group such as 2-hydroxyethyl (meth) acrylate, 2-hydroxypropyl (meth) acrylate, 3-hydroxypropyl (meth) acrylate, 2-hydroxybutyl (meth) acrylate, 3-hydroxybutyl (meth) acrylate, 4-hydroxybutyl (meth) acrylate, may be contained. These monomer compounds may be used alone or in combination of two or more kinds thereof.

The content of the constituent unit derived from the monomer compound in the styrene-(meth)acrylic resin is, for example, preferably in a range of 0.5 to 20% by mass with respect to the total amount of the resin. The mass average molecular weight (Mw) of the styrene-(meth)acrylic resin is preferably, for example, in a range of 10000 to 100000.

### (1-2. Other Components)

The toner base particles may contain a release agent (wax), a colorant, a charge control agent, and the like.

### (1-2-1. Release Agent)

The release agent can improve the releasability of the toner from the fixing member or the like.

Examples of the release agent include a hydrocarbon wax including a polyethylene wax, a paraffin wax, a microcrystalline wax, a Fischer-Tropsch wax and the like, a dialkyl ketone wax including distealyl ketone and the like, an ester wax including carnauba wax, montan wax, behenyl behenate, behenic acid behenate, trimethylolpropane tribehenate, pentaerythritol tetramyristate, pentaerythritol tetrastearate, pentaerythritol tetrabehenate, pentaerythritol diacetate dibehenate, glycerin tribehenate, 1,18-octadecandiol distearate, trimellitic acid tristealyl, distealyl maleate and the like, and an amide wax including ethylenediamine dibehenylamide, trimellitic acid tristearylamide and the like.

The content of the release agent is preferably 2% by mass or more and 30% by mass or less, more preferably 5% by mass or more and 20% by mass or less based on the total mass of the toner base particle. When the content of the release agent is 2% by mass or more, the releasability of the toner from the fixing member is sufficiently enhanced. When the content of the release agent is 30% by mass or less, a sufficient amount of the binder resin can be contained in the toner base particles, and the fixability of the image is sufficiently enhanced.

### (1-2-2. Colorant)

The toner base particle may contain a colorant. When the toner base particles contain a colorant, various known colorants such as carbon black, magnetic body, black iron oxide, dye, and pigment can be used as the colorant.

Examples of carbon black include channel black, furnace black, acetylene black, thermal black, and lamp black.

As the magnetic body, a ferromagnetic metal such as iron, nickel, or cobalt, an alloy containing these metals, a compound of a ferromagnetic metal such as ferrite or magnesium, or the like can be used.

Specific examples of the black iron oxide include, but are not limited to, magnetite, hematite, and titanium iron trioxide.

An example of the dye includes C.I. Solvent Red 1, C.I. Solvent Red 49, C.I. Solvent Red 52, C.I. Solvent Red 58, C.I. Solvent Red 63, C.I. Solvent Red 111, C.I. Solvent Red 122, C.I. Solvent Yellow 19, C.I. Solvent Yellow 44, C.I. Solvent Yellow 77, C.I. Solvent Yellow 79, C.I. Solvent Yellow 81, C.I. Solvent Yellow 82, C.I. Solvent Yellow 93, C.I. Solvent Yellow 98, C.I. Solvent Yellow 103, C.I. Solvent Yellow 104, C.I. Solvent Yellow 112, C.I. Solvent Yellow 162, C.I. Solvent Blue 25, C.I. Solvent Blue 36, C.I. Solvent Blue 60, C.I. Solvent Blue 70, C.I. Solvent Blue 93, C.I. Solvent Blue 95 and the like.

Examples of the pigments include C.I. Pigment Red 5, C.I. Pigment Red 48:1, C.I. Pigment Red 48:3, C.I. Pigment Red 53:1, C.I. Pigment Red 57:1, C.I. Pigment Red 81:4, C.I. Pigment Red 122, C.I. Pigment Red 139, C.I. Pigment Red 144, C.I. Pigment Red 149, C.I. Pigment Red 150, C.I. Pigment Red 166, C.I. Pigment Red 177, C.I. Pigment Red 178, C.I. Pigment Red 222, C.I. Pigment Red 238, C.I. Pigment Red 269, C.I. Pigment Orange 31, C.I. Pigment Orange 43, C.I. Pigment Yellow 14, C.I. Pigment Yellow 17, C.I. Pigment Yellow 74, C.I. Pigment Yellow 93, C.I. Pigment Yellow 94, C.I. Pigment Yellow 138, C.I. Pigment Yellow 155, C.I. Pigment Yellow 156, C.I. Pigment Yellow 158, C.I. Pigment Yellow 180, C.I. Pigment Yellow 185, C.I. Pigment Green 7, C.I. Pigment Blue 15:3, C.I. Pigment Blue 60 and the like.

The colorant for obtaining the toner of each color can be used singly or in combination of two or more kinds for each color.

The content ratio of the colorant is preferably 1 to 10 parts by mass, and more preferably 2 to 8 parts by mass, relative to 100 parts by mass of the binder resin in the toner base particle. When the content of the colorant is within the above-described range, a desired coloring power is easily obtained for the toner to be obtained, and the influence on chargeability is small and the colorant is less likely to be released or adhere to a carrier or the like.

### (1-2-3. Charge Control Agent)

The charge control agent can adjust the chargeability of the toner base particles.

Examples of the charge control agent include a nigrosine dye, a naphthenic acid, a metal salt of a higher fatty acid, an alkoxylated amine, a quaternary ammonium salt compound, an azo metal complex, a salicylic acid metal salt, and a metal complex thereof.

The content of the charge control agent is preferably 0.1% by mass or more and 10% by mass or less and more preferably 0.5% by mass or more and 5% by mass or less based on the total mass of the binder resin. When the chargeability of the toner is intended to be controlled by a method of adding the charge control agent in excess or the like, other properties of the toner base particles may be largely changed. In contrast, in the present embodiment, in order to adjust the chargeability of the toner by alumina, the chargeability of the toner can also be adjusted to a desired degree while satisfying other required characteristics.

### (2. External Additive)

The toner base particles can be directly used as a toner; however, it is preferable that an external additive is caused to adhere to the surfaces of the toner base particles in order to improve the fluidity, chargeability, cleaning property, and the like of the toner. Examples of the external additive include fine particles such as well-known inorganic fine particles and organic fine particles, and a lubricant. Various external additives may be used in combination.

Preferred examples of the inorganic fine particles include inorganic fine particles of silica, titania (titanium oxide), alumina, strontium titanate, zinc titanate, calcium titanate, and the like. Two or more of these may be used in combination. The number-average primary particle diameter of the inorganic particles is preferably about 10 to 100 nm. The number average primary particle diameter of the inorganic fine particle can be measured by, for example, a method in which with respect to an image photographed using a scanning electron microscope (SEM), Feret's diameters in the horizontal direction of 100 particles are calculated using an image processing and analyzing apparatus or the like and the average value is determined.

These inorganic fine particles may be hydrophobized by surface modification, if necessary. Use of hydrophobized inorganic fine particles can prevent adhesion of the white toner base particles (Am) to each other due to moisture adsorption, which occurs, for example, due to hydroxy groups present on the surfaces of the inorganic oxide particles.

Examples of the surface modifier used for modifying the surfaces of the inorganic fine particles include a silane coupling agent and a titanium coupling agent. As the silane coupling agent, dimethyldimethoxysilane, hexamethyldisilazane (HMDS), methyltrimethoxysilane, isobutyltrimethoxysilane, decyltrimethoxysilane and the like are preferable. In addition, as a surface modifier, higher fatty acid and silicone oil can be used. As the silicone oil, organosiloxane oligomer, octamethylcyclotetrasiloxane, or cyclic compounds such as decamethylcyclopentasiloxane, tetramethylcyclotetrasiloxane, and tetravinyltetramethylcyclotetrasiloxane, or linear or branched organosiloxane can be used.

The amount of the external additive to be added is preferably 0.05 to 5 parts by mass, more preferably 0.1 to 3 parts by mass, relative to 100 parts by mass of the toner base particles.

### (3. Method of Producing Toner Base Particles)

The toner base particles can be produced by a method such as a kneading-pulverization method, a suspension polymerization method, a dissolution suspension method, a polyester elongation method, an emulsion polymerization aggregation method, or an emulsion aggregation method, in the same manner as the known toner.

In particular, the emulsion polymerization aggregation method and the emulsion aggregation method are more preferable, in which dispersibility of colorant fine particles in a dispersion liquid of a colorant contained in the toner base particle is excellent, and furthermore, even in a case where the colorant fine particles and binder resin fine particles are aggregated and fused, the toner base particle can be formed while the colorant fine particles maintain excellent dispersibility.

In the emulsion polymerization aggregation method, a dispersion liquid of particles of a binder resin obtained by an emulsion polymerization method and a dispersion liquid of particles of a pigment are mixed together with optionally added particles such as a release agent and a charge control agent, and these are aggregated, associated, or fused until particles having a desired particle diameter are obtained, so that toner base particles can be produced. An external additive is then added to the toner base particles to form toner particles.

In the emulsion aggregation method, a dispersion liquid of binder resin particles, which is obtained by adding dropwise a solution containing a binder resin dissolved therein to a poor solvent, is mixed with a dispersion liquid of pigment particles and optionally added particles such as a release agent and a charge control agent, and these are aggregated, associated, or fused until particles having a desired particle diameter are obtained, so that toner base particles can be produced. An external additive is then added to the toner base particles to form toner particles.

### (Aggregating Agent)

The aggregating agent used in the emulsion polymerization aggregation method and the emulsion aggregation method is not particularly limited, but one selected from metal salts such as alkali metal salts and alkaline earth metal salts is suitably used. Examples of the metal salt include a metal salt of a monovalent such as sodium, potassium, or lithium, a metal salt of a divalent such as calcium, magnesium, manganese, or copper, and a metal salt of a trivalent such as iron or aluminum. Specific examples of the metal salt include sodium chloride, potassium chloride, lithium chloride, calcium chloride, magnesium chloride, zinc chloride, copper sulfate, magnesium sulfate, and manganese sulfate, and among these, use of a divalent metal salt is particularly preferable from the viewpoint that aggregation can more stably proceed. These may be used alone or in combination of two or more kinds thereof.

### (4. Carrier)

The carrier is mixed with the above-described toner particles to form a two-components magnetic toner. The carrier may be any known magnetic particle that can be contained in a toner.

Examples of the magnetic particles include particles containing magnetic body such as iron, steel, nickel, cobalt, ferrite, and magnesium, and alloys of these materials with aluminum, lead, and the like. The carrier may be a coated carrier in which the surface of a particle formed of magnetic body is coated with a resin or the like, or may be a resin-dispersed carrier in which magnetic body is dispersed in a binder resin. Examples of the resin for coating include an olefin resin, a styrene resin, a styrene acrylic resin, a silicone resin, a polyester resin, and a fluororesin. Examples of the binder resin include acrylic resins, styrene acrylic resins, polyester resins, fluororesins, and phenol resins.

The average particle size of the carrier is, in terms of volume-based average particle size, preferably 20 μm or more and 100 μm or less, more preferably 25 μm or more and 80 μm or less. The average particle diameter of the carrier can be measured with HELOS (manufactured by SYMPATEC Co., Ltd) which is a laser diffraction type particle size distribution measuring device equipped with a wet dispersing machine.

The content of the carrier is preferably 2% by mass or more and 10% by mass or less with respect to the total mass of the toner particles and the carrier.

### [System Block Diagram of Image Forming Apparatus]

FIG. 2 illustrates a block diagram of a configuration example of the image forming apparatus 1.

As illustrated in FIG. 2, the image forming apparatus 1 includes the image forming apparatus main body 40, the sheet feed section 10, the controller 41, the operation display unit 42, the conveying portion 44, the image forming section 46, the fixing section 47, a storage section 48, and the collection section 60. Description of configurations that overlap the above-described image forming apparatus 1 illustrated in FIG. 1 will be omitted in the following description.

The controller 41 of the image forming apparatus 1 includes, for example, a CPU (Central Processing Unit), a RAM (Random Access Memory), a ROM (Read Only Memory), and the like (not shown). The CPU of the controller 41 reads various processing programs stored in the ROM, develops the programs in the RAM, and integrally controls the operations of the respective units of the image forming apparatus main body 40 such as the sheet feed section 10, the operation display unit 42, the conveying portion 44, the image forming section 46, the fixing section 47, and the storage section 48 connected via the system bus according to the developed programs.

The storage section 48 includes a non-volatile memory such as an electrically erasable and programmable read only memory (EEPROM) or a flash memory. The storage section 48 stores a program to be executed by the controller 41 and the like, and is used as a work area for the controller 41. The storage section 48 also stores image forming conditions set in an image forming job, recording material information including the size and type of the recording material S, and the like. Further, examples of the image forming conditions stored in the storage section 48 include an execution condition in the image forming section 46 including an interval between images continuously formed on the recording material S and an execution condition in the fixing section 47.

In addition, the controller 41 acquires image data from the input job information and performs image processing. The controller 41 performs image processing such as shading correction, image density adjustment, and image compression on the acquired image data as necessary. The image data processed by the controller 41 is transmitted to the image forming section 46.

The conveying portion 44 conveys the recording material S fed from the sheet feed section 10 to the image forming section 46, the fixing section 47, and the like based on the control of the controller 41. The sheet feed section 10 feeds the recording material S such as roll sheet to the image forming apparatus main body 40 by driving of the conveying portion 44. Further, the conveying portion 44 conveys the recording material S after image formation to the collection section 60. The collection section 60 winds and collects the recording material S such as roll sheet carried out from the image forming apparatus main body 40 by the driving of the conveying portion 44.

The image forming section 46 receives image data subjected to image processing by the controller 41, and forms an image on the recording material S conveyed to the image forming section 46 by the conveying portion 44 based on the image data.

The operation display unit 42 displays various operation buttons, a state of the apparatus, an operation status of each function, and the like on a display screen in accordance with an instruction of a display signal input from the controller 41. Further, the operation display unit 42 receives an input of data such as various instructions, characters, and numerals by a user's operation, and outputs an input signal to the controller 41.

### EXAMPLES

Hereinafter, the present invention will be described in more detail with reference to Examples, but the present invention is not limited thereto.

### <Preparation of Toner>

Toners (1) to (3) were prepared by the following method. The toner (1) contains an amorphous polyester (Pes) and a crystalline polyester (Pes) as a binder resin. The toner (2) contains a styrene acrylic resin (St-Ac), an amorphous polyester (Pes), and a crystalline polyester (Pes) as a binder resin. Toner (3) contains only an amorphous polyester (Pes) as a binder resin. The toners (1) to (3) have the same configuration except for the binder resin.

### [Preparation of Colorant Particle Dispersion Liquid]

While stirring a solution of 226 parts by mass of sodium dodecylsulfate in 1600 parts by mass of ion-exchanged water, 420 parts by mass of copper phthalocyanine (C. I. Pigment Blue 15:3) was gradually added. A colorant particle dispersion liquid (P1) was prepared by performing a dispersion treatment using a stirring device CLEARMIX (manufactured by M Technique Co., Ltd., “CLEARMIX” is a registered trademark of the company). The colorant particles in the dispersion liquid had a volume-based median diameter of 110 nm.

### [Preparation of Amorphous Resin Particle Dispersion Liquid]

(Preparation of Amorphous Polyester Resin Particle Dispersion Liquid (a1))
Bisphenol A ethylene oxide 2.2 mol adduct: 40 parts by mol
Bisphenol A propylene oxide 2.2 mol adduct: 60 parts by mol
Dimethyl terephthalate: 60 parts by mole
Dimethyl fumarate: 15 parts by mole
Dodecenylsuccinic anhydride: 20 parts by mole
Trimellitic anhydride: 5 parts by mole

Into a reaction vessel equipped with a stirrer, a thermometer, a condenser and a nitrogen gas introduction tube, the above monomers other than dimethyl fumarate and trimellitic anhydride, and tin dioctylate in an amount of 0.25 parts by mass relative to 100 parts by mass of the total of the above-mentioned monomers, were added. After reacting for 6 hours at 235° C. under a nitrogen gas flow, the temperature was lowered to 200° C., the above amounts of dimethyl fumarate and trimellitic anhydride were added, and the mixture was reacted for 1 hour. The temperature was raised to 220° C. over 5 hours, and polymerization was carried out under 10 kPa until the desired molecular weight was reached, thus obtaining a light yellow transparent amorphous polyester resin (A1).

The amorphous polyester resin (A1) had a mass average molecular weight of 35000, a number average molecular weight of 8000, and a glass transition temperature (Tg) of 56° C.

Next, 200 parts by mass of the amorphous polyester resin (A1), 100 parts by mass of methylethyl ketone, parts by mass of isopropyl alcohol, and 7.0 parts by mass of a 10% by mass aqueous ammonia solution were placed in a separable flask and, after thorough mixing and dissolution, ion-exchanged water was added dropwise at a liquid feed rate of 8 g/min using a liquid feed pump while heating and stirring at 40° C., and the dropwise addition was stopped when the liquid feed amount reached 580 parts by mass Thereafter, the solvent was removed under reduced pressure to obtain an amorphous polyester resin particle dispersion liquid. Ion-exchanged water was added to the dispersion liquid to adjust the solid content to 25% by mass, thereby preparing an amorphous polyester resin particle dispersion liquid (a1).

The volume-based average particle size of the amorphous polyester resin (a1) in the amorphous polyester resin particle dispersion liquid (a1) was 156 nm.

(Preparation of Styrene-Acrylic Resin Particle Dispersion Liquid (b1))

### (First Stage Polymerization)

Into a reaction vessel 5 L equipped with a stirring device, a temperature sensor, a cooling pipe and a nitrogen-introducing device, 8 parts by mass of sodium dodecylsulfate and 3000 parts by mass of ion-exchanged water were charged, and the internal temperature was raised to 80° C. under a nitrogen gas flow while stirring at a stirring speed of a 230 rpm. After the temperature rise, a solution prepared by dissolving 10 parts by mass of potassium persulfate in 200 parts by mass of ion-exchanged water was added, the liquid temperature was again set to 80° C., and a mixed liquid of the following monomers was added dropwise over 1 hour.
Styrene: 480.0 parts by mass
N-butyl acrylate: 250.0 parts by mass
Methacrylic acid: 68.0 parts by mass

After the dropwise addition of the mixture, the mixture is heated and stirred at 80° C. for 2 hours to polymerize the monomers, thereby preparing a vinyl-based resin particle dispersion liquid S1.

### (Second Stage Polymerization)

A 5 L reaction vessel equipped with a stirrer, a thermometer, a cooling tube, and a nitrogen-introducing device was charged with 100 parts by mass of ion-exchanged water and 55 parts by mass, in terms of solids, of the vinyl-based resin particle dispersion liquid S1 prepared in the first stage polymerization and heated to 87° C. Thereafter, a mixed liquid in which the following monomers, a chain transfer agent (n-octyl-3-mercaptopropionate), and a release agent (paraffin wax: manufactured by NIPPON SEIRO CO., LTD., HNP0190) were dissolved at 85° C. and is subjected to a mixing and dispersing treatment for 10 minutes with a mechanical dispersing machine (manufactured by M Technique Co., Ltd., CLEARMIX) having a circulating path, and thereby a dispersion liquid containing emulsified particles (oil droplets) was prepared. This dispersion liquid was added to the 5 L reaction vessel, a polymerization initiator solution in which 5.4 parts by mass of potassium persulfate was dissolved in 103 parts by mass of ion-exchanged water was added, and this system was heated and stirred at 87° C. for 1 hour to perform polymerization, thereby preparing a vinyl-based resin particle dispersion liquid S
Styrene: 256.5 parts by mass
2-ethylhexyl acrylate: 95.3 parts by mass
Methacrylic acid: 38.2 parts by mass
Chain transfer agent: 4.0 parts by mass
Releasing agent: 133.4 parts by mass

### (Third Stage Polymerization)

To the vinyl-based resin particle dispersion liquid S1′ obtained through the second polymerization, a solution of 7.3 parts by mass of potassium persulfate in 157.9 parts by mass of ion-exchanged water was added. Further, under a temperature condition of 84° C., a mixed solution of the following monomers and a chain transfer agent (n-octyl-3-mercaptopropionate) was added dropwise over 90 minute.
Styrene: 370.0 parts by mass
N-Butyl acrylate: 165.0 parts by mass
Methacrylic acid: 40.0 parts by mass
Methyl methacrylate: 47.2 parts by mass
Chain transfer agent: 8.6 parts by mass

After the completion of the dropwise addition, the mixture was heated and stirred for 2 hours for polymerization and then cooled to 28° C. to obtain fine particles composed of an amorphous vinyl resin containing a release agent (amorphous vinyl resin: 89% by mass, release agent: 11% by mass). Ion-exchanged water was added to the dispersion liquid such that the solid content was adjusted to 30% by mass, thereby obtaining an amorphous vinyl resin particle dispersion liquid (b1).

### [Preparation of Crystalline Resin Particle Dispersion Liquid]

(Preparation of Crystalline Polyester Resin Particle Dispersion Liquid (c1))
Dodecanedioic acid: 50 parts by mole
1,6-Hexanediol: 50 parts by mol

The above monomers were put into a reaction vessel equipped with a stirrer, a thermometer, a condenser, and a nitrogen gas introduction pipe, and the inside of the reaction vessel was purged with a dry nitrogen gas. Next, titanium tetrabutoxide (Ti[O(CH₂)₃CH₃]₄) was added in an amount of 0.25 parts by mass relative to 100 parts by mass of the above monomers were added. The mixture was stirred at 170° C. for 3 hours under a nitrogen gas flow and heated to 210° C. over 1 hour, the pressure in the reaction vessel was reduced to 3 kPa, and the mixture was stirred under reduced pressure for 13 hours to produce a crystalline polyester resin (C1). The crystalline polyester resin (C1) had a mass average molecular weight of 25000, a number average molecular weight of 8500, and a melting point of 71.8° C.

Next, 200 parts by mass of the crystalline polyester resin (C1), 120 parts by mass of methyl ethyl ketone, and 30 parts by mass of isopropyl alcohol were put into a separable flask and were sufficiently mixed and dissolved at 60° C., and then 8 parts by mass of a 10% by mass aqueous ammonia solution was added dropwise thereto. The heating temperature was decreased to 67° C., and while stirring, ion-exchanged water was added dropwise using a liquid feed pump at a liquid feed rate of 8 g/minute, and when the liquid feed amount reached 580 parts by mass, the dropwise addition of ion-exchanged water was stopped. Thereafter, the solvent was removed under reduced pressure to obtain a crystalline polyester resin particle dispersion liquid. Ion-exchanged water was added to the dispersion liquid to adjust the solid content thereof to 25% by mass, thereby preparing a crystalline polyester resin particle dispersion liquid (c1). The volume-based average particle size of the crystalline polyester resin particles (C1) in the crystalline polyester resin particle dispersion liquid (C1) was 198 nm.

### [Preparation of Release Agent Particle Dispersion Liquid (W1)]

Paraffin wax: 270 parts by mass
Anionic surfactant: 13.5 parts by mass
(active ingredient 60%, 3% relative to paraffin wax)
Ion-exchanged water: 21.6 parts by mass

The above materials were mixed, and in a pressure-ejection homogenizer (Gorin homogenizer, manufactured by Gorin Corporation), the release agent was dissolved at an internal liquid temperature of 120° C., and then the mixture was dispersed under a dispersion pressure of 5 MPa for 120 minutes and subsequently under 40 MPa for 360 minutes, and cooled to obtain a dispersion liquid. Ion-exchanged water was added thereto such that the solid content was adjusted to 20%, thereby preparing a release agent dispersion liquid (W1). The volume-average particle size of the particles in the release agent dispersion liquid (W1) was 215 nm.

Note that the paraffin wax is HNP0190 (melt temperature: 85° C.) available from NIPPON SEIRO CO., LTD, and the anionic surfactant is NEOGEN RK available from Dai-ichi Kogyo Seiyaku Co., Ltd.

### [Preparation of Toner Base Particles]

### (Preparation of Toner Base Particle (1))

Amorphous polyester resin particle dispersion liquid (a1): 1280 parts by mass
Crystalline polyester resin particle dispersion liquid (c1): 160 parts by mass
Release agent particle dispersion liquid (W1): 200 parts by mass
Colorant particle dispersion liquid (P1): 335 parts by mass
Anionic surfactant: 40 parts by mass
ion-exchanged water: 1500 parts by mass

The above materials were placed in a 4-liter reaction vessel equipped with a thermometer, a pH meter and a stirrer, and a 1.0% by mass nitric acid aqueous solution was added at a temperature of 25° C. to adjust the pH to 3.0. Thereafter, 100 parts by mass of a 2.0% by mass aqueous solution of aluminum sulfate (aggregating agent) was added thereto over 30 minutes while dispersing at 3000 rpm using a homogenizer (manufactured by IKA, Ultra-Turrax T50). After the completion of the dropwise addition, the mixture was stirred for 10 minutes to thoroughly mix the raw materials with the aggregating agent.

Thereafter, a stirrer and a mantle heater were installed in the reaction vessel, and the temperature was raised at a temperature rising rate of 0.2° C./min up to 40° C. and at a temperature rising rate of 0.05° C./min after exceeding 40° C. while adjusting the number of revolutions of the stirrer so as to sufficiently stir the slurry, and the particle diameter was measured every 10 minutes by a particle size distribution measuring device (Coulter Multisizer 3 (aperture diameter 100 μm)), manufactured by Beckman Coulter, Inc). When the volume-based average particle diameter reached 5.9 μm, the temperature was maintained, and a mixed liquid of the following materials which had been mixed in advance was added over 20 minute.
Amorphous polyester resin particle dispersion liquid (a1): 160 parts by mass
Anionic surfactant: 15 parts by mass

All of the anionic surfactants added twice are DOWFAX 2A1 (20% aqueous solutions) manufactured by Dow Chemical Company.

Next, after maintaining the temperature at 50° C. for 30 minutes, 8 parts by mass of a 20% by mass aqueous solution of ethylenediaminetetraacetic acid (EDTA) was added to the reactor, and then a 1 mol/L aqueous solution of sodium hydroxide was added to control the pH level of the raw material dispersion liquid to 9.0. Thereafter, the temperature was raised to 85° C. at a temperature rising rate of 1° C./min while the pH was adjusted to 9.0 every 5° C., and the temperature was held at 85° C.

Thereafter, when the shape factor measured using a particle size analyzer (FPIA 3000, manufactured by Malvern Instruments Ltd) reached 0.970, the mixture was cooled at a temperature dropping rate of 10° C./min to obtain a toner base particle dispersion liquid (1).

Thereafter, the solid content obtained by filtering the toner base particle dispersion liquid (1) was sufficiently washed with ion-exchanged water. Next, drying was performed at 40° C. to obtain toner base particle (1). The volume-based average particle diameter of the obtained toner base particles (1) was 6.0 μm, and the average circularity measured using a particle size analyzer (FPIA 3000, manufactured by Malvern Instruments Ltd) was 0.972.

### (Preparation of Toner Base Particles (2))

Styrene-acrylic resin particle dispersion liquid (b1): 1200 parts by mass
Crystalline polyester resin particle dispersion liquid (c1): 160 parts by mass
Colorant particle dispersion liquid (P1): 335 parts by mass
Anionic surfactant: 40 parts by mass
ion-exchanged water: 1500 parts by mass

The above materials were placed in a 4-liter reaction vessel equipped with a thermometer, a pH meter and a stirrer, and a 1.0% by mass nitric acid aqueous solution was added at a temperature of 25° C. to adjust the pH to 3.0. Thereafter, 100 parts by mass of a 2.0% by mass aqueous solution of aluminum sulfate (aggregating agent) was added thereto over 30 minutes while dispersing at 3000 rpm using a homogeniser (manufactured by IKA, Ultra-Turrax T50). After the completion of the dropwise addition, the mixture was stirred for 10 minutes to thoroughly mix the raw materials with the aggregating agent.

Thereafter, a stirrer and a mantle heater were installed in the reaction vessel, and the temperature was raised at a temperature rising rate of 0.2° C./min up to 40° C. and at a temperature rising rate of 0.05° C./min after exceeding 40° C. while adjusting the number of revolutions of the stirrer so as to sufficiently stir the slurry, and the particle diameter was measured every 10 minutes by a particle size distribution measuring device (Coulter Multisizer 3 (aperture diameter 100 μm)), manufactured by Beckman Coulter, Inc). When the volume-based average particle diameter reached 5.9 μm, the temperature was maintained, and a mixed liquid of the following materials which had been mixed in advance was added over 20 minute.
Amorphous polyester resin particle dispersion liquid (a1): 160 parts by mass
Anionic surfactant: 15 parts by mass

All of the anionic surfactants added twice are DOWFAX 2A1 (20% aqueous solutions) manufactured by Dow Chemical Company.

Next, after maintaining the temperature at 50° C. for 30 minutes, 8 parts by mass of a 20% by mass aqueous solution of ethylenediaminetetraacetic acid (EDTA) was added to the reactor, and then a 1 mol/L aqueous solution of sodium hydroxide was added to control the pH level of the raw material dispersion liquid to 9.0. Thereafter, the temperature was raised to 85° C. at a temperature rising rate of 1° C./min while the pH was adjusted to 9.0 every 5° C., and the temperature was held at 85° C.

When the shape factor measured with a particle size analyzer (FPIA 3000 available from Malvern Instruments Ltd) reached 0.970, the mixture was cooled at a temperature dropping rate of 10° C./min to obtain toner base particle dispersion liquid (2).

The solid content obtained by filtering the toner base particle dispersion liquid (2) was sufficiently washed with ion-exchanged water. Next, the resultant was dried at 40° C. to obtain toner base particles (2). The obtained toner base particles (2) had a volume-based average particle size of 6.0 μm and an average circularity of 0.972 as measured using a particle size meter (FPIA-3000, manufactured by Malvern Corporation).

### (Preparation of Toner Base Particles (3))

Amorphous polyester resin particle dispersion liquid (a1): 1440 parts by mass
Release agent particle dispersion liquid (W1): 200 parts by mass
Colorant Particle Dispersion liquid (P1): 335 parts by mass
Anionic surfactant: 40 parts by mass
ion-exchanged water: 1500 parts by mass

The above materials were placed in a 4-liter reaction vessel equipped with a thermometer, a pH meter and a stirrer, and a 1.0% by mass nitric acid aqueous solution was added at a temperature of 25° C. to adjust the pH to 3.0. Thereafter, 100 parts by mass of a 2.0% by mass aqueous solution of aluminum sulfate (aggregating agent) was added thereto over 30 minutes while dispersing at 3000 rpm using a homogeniser (manufactured by IKA, Ultra-Turrax T50). After the completion of the dropwise addition, the mixture was stirred for 10 minutes to thoroughly mix the raw materials with the aggregating agent.

Thereafter, a stirrer and a mantle heater were installed in the reaction vessel, and the temperature was raised at a temperature rising rate of 0.2° C./min up to 40° C. and at a temperature rising rate of 0.05° C./min after exceeding 40° C. while adjusting the number of revolutions of the stirrer so as to sufficiently stir the slurry, and the particle diameter was measured every 10 minutes by a particle size distribution measuring device (Coulter Multisizer 3 (aperture diameter 100 μm)), manufactured by Beckman Coulter, Inc). When the volume-based average particle diameter reached 5.9 μm, the temperature was maintained, and a mixed liquid of the following materials which had been mixed in advance was added over 20 minute.
Amorphous polyester resin particle dispersion liquid (a1): 160 parts by mass
Anionic surfactant: 15 parts by mass

All of the anionic surfactants added twice are DOWFAX 2A1 (20% aqueous solutions) manufactured by Dow Chemical Company.

Next, after maintaining the temperature at 50° C. for 30 minutes, 8 parts of a 20% solution of ethylenediaminetetraacetic acid (EDTA) was added to the reactor, and then an aqueous sodium hydroxide solution (1 mol/L) was added to control the pH level of the raw material dispersion liquid to 9.0. Thereafter, the temperature was raised to 85° C. at a temperature rising rate of 1° C./min while the pH was adjusted to 9.0 every 5° C., and the temperature was held at 85° C.

Thereafter, when the shape factor measured using a particle size analyzer (FPIA 3000, manufactured by Malvern Instruments Ltd) reached 0.970, the mixture was cooled at a temperature dropping rate of 10° C./min to obtain a toner base particle dispersion liquid (3).

Thereafter, the solid content obtained by filtering the toner base particle dispersion liquid (3) was sufficiently washed with ion-exchanged water. Next, drying was performed at 40° C. to obtain toner base particle (3). The volume-based average particle diameter of the obtained toner base particles (3) was 6.0 μm, and the average circularity measured using a particle size analyzer (FPIA 3000, manufactured by Malvern Instruments Ltd) was 0.972.

### [Preparation of Carrier]

### (Preparation of Core Material Particles)

MnO: 35.0 mol %
MgO: 14.5 mol %
Fe₂O₃: 50.0 mol %
SrO: 0.5 mol %

The raw materials were weighed so as to achieve the above ratio of amounts, mixed with water, and then ground in a wet media mill for 5 hours to obtain a slurry.

The obtained slurry was dried with a spray dryer to obtain true spherical particles. The particles were subjected to particle size adjustment, and then heated at 950° C. for 2 hours and calcinated in a rotary kiln. After grinding for 1 hour in a dry-ball mill using 0.3 cm stainless steel beads, polyvinyl alcohol (PVA) was added as a binder in an amount of 0.8 wt % with respect to the solids content, and the mixture was further added with water and a polycarboxylic acid-based dispersing agent and ground for 30 hours using 0.5 cm zirconia beads. The obtained powder was granulated and dried by a spray dryer, and held in an electric furnace at a temperature of 1050° C. for 15 hours to perform baking.

The powder after baking was crushed and further classified to adjust the particle size, and then a low magnetic force product was fractionated by magnetic separation to obtain core material particles. The volume average particle diameter of the core material particles was 30 μm.

The volume average particle diameter of the core material particles is a value obtained by performing measurement according to a wet method using a laser diffraction particle size distribution measuring device (HEROSKA, manufactured by Nippon Laser Co., Ltd). Specifically, first, the optical system at the focal position 200 mm was selected, and the measurement time was set to 5 seconds. Next, the core material particles for measurement are added to a 0.2% by mass aqueous solution of sodium dodecyl sulfate and dispersed for 3 minutes using an ultrasonic cleaner (US-1, manufactured by Asone Corporation) to prepare a sample dispersion liquid for measurement. Several droplets of the dispersion liquid were supplied to the laser diffraction particle size distribution measuring device, and the measurement was started when the sample concentration gauge reached a measurable region. Regarding the obtained particle size distribution, a cumulative distribution was created from the small diameter side with respect to the particle size range (channel), and a particle diameter (D50) at which the cumulative percentage reached 50% was defined as the volume average particle diameter.

### (Preparation of Resin for Coating)

Cyclohexyl methacrylate and methyl methacrylate in amounts such that the mass ratio (copolymerization ratio) was 70:30, and potassium persulfate in an amount corresponding to 0.5% by mass of the total amount of monomers were added to a 0.3% by mass aqueous solution of sodium benzenesulfonate, and emulsion polymerization was performed. Thereafter, it was dried by spray drying to prepare a coating resin. The coating resin had a mass average molecular weight of 500000.

### (Preparation of Carrier)

Into a high-speed stirring mixer equipped with a horizontal stirring blade, 100 parts by mass of the core particles prepared as described above and 4.5 parts by mass of the coating resin prepared as described above were introduced, and these were mixed and stirred at 22° C. for 15 minutes under conditions where the peripheral speed of the horizontal rotating blade was 8 msec. Thereafter, the mixture was mixed at 120° C. for 50 minutes to coat the surfaces of the core material particles with the coating material by the action of mechanical impact force (mechanochemical method), and then cooled to room temperature to produce a carrier.

### [Preparation of Electrostatic Charge Image Developing Toner]

### (Preparation of Toner (1))

10 parts by mass of alumina and 1.5 parts by mass of silica (number-average particles size: 20 nm) were added to 100 parts by mass of toner base particles (1) and mixed with a Henschel mixer for 20 minutes. Thereafter, the resultant was mixed with the carrier so as to have a toner concentration of 9% by mass, and the mixture was mixed at 25° C. for 30 minutes using a V-type mixer (manufactured by Tokuju Corporation), thereby preparing a toner (1) as an electrostatic charge image developing toner (developer).

Note that the number-average particle size of the silica particles was determined as follows: using a scanning electron microscope (SEM) (JEM-7401F, manufactured by JEOL Ltd), an SEM photograph magnified 50000 times was taken by a scanner, and using an image processing and analyzing apparatus (LUZEXAP, manufactured by Nireco, Inc), the silica particles in the SEM photograph image were subjected to binarization processing, and the Feret's diameters in the horizontal direction of 100 silica particles were calculated.

### (Preparation of Toners (2) to (3))

A toner (2) and a toner (3) were prepared in the same manner as the toner (1) except that the toner base particles (2) or (3) are used instead of the toner base particles (1).

### (Preparation of Developer)

Developers (1) to (3) were prepared by mixing the prepared toners (1) to (3) with the prepared carrier such that the toner concentration was 6% by mass

### <Secondary Transfer Roller>

### [Preparation of Porous Elastic Layer Material 1]

10 parts by mass of NBR (Nipol DN3335, manufactured by Zeon Corporation), 90 parts by mass of epichlorohydrin (Hydrin T3106, manufactured by Zeon Corporation), 5 parts by mass of XFC carbon (VULCAN P, manufactured by Cabot Corporation), 10 parts by mass of calcium carbonate, 5 parts by mass of zinc oxide, 1 part by mass of stearic acid, 10 parts by mass of process oil (Diana Process PW380, manufactured by Idemitsu Petrochemical Co., Ltd), 15 parts by mass of dinitrosopentamethylenetetramine (foaming agent), 1 part by mass of sulfur, 1 part by mass of dibenzo thiazole sulfide (crosslinking accelerator) and 1 part by mass of tetramethyl thiuram monosulfide (crosslinking accelerator) were kneaded to prepare a foamed material 1 for forming a porous elastic layer.

### [Preparation of Porous Elastic Layer Material 2]

A foamed material 2 for forming a porous elastic layer was obtained in the same manner as the foamed material 1 for forming a porous elastic layer, except that the amount of NBR (NIPOL DN3335 produced by Zeon Corporation) was changed to 20 parts by mass, the amount of epichlorohydrin (Hydrin T3106 produced by Zeon Corporation) was changed to 80 parts by mass, and the amount of dinitrosopentamethylenetetramine (foaming agent) was changed to 10 parts by mass.

### [Preparation of Porous Elastic Layer Material 3]

A foamed material 3 for forming for forming a porous elastic layer was obtained in the same manner as the foamed material 1 for forming a porous elastic layer, except that the amount of NBR (NIPOL DN3335 manufactured by Zeon Corporation) was changed to 55 parts by mass, the amount of epichlorohydrin (Hydrin T3106 manufactured by Zeon Corporation) was changed to 45 parts by mass, the amount of XFC carbon (VULCAN P manufactured by Cabot Corporation) was changed to 15 parts by mass, and the amount of dinitrosopentamethylenetetramine (foaming agent) was changed to 7 parts by mass.

### [Preparation of Porous Elastic Layer Material 4]

A foamed material 4 for forming a porous elastic layer was obtained in the same manner as the foamed material 1 for forming a porous elastic layer except that the amount of NBR (Nipol DN3335, manufactured by Zeon Corporation) was changed to 60 parts by mass, the amount of epichlorohydrin (Hydrin T3106, manufactured by Zeon Corporation) was changed to 40 parts by mass, the amount of XFC carbon (Vulcan P, manufactured by Cabot Corporation) was changed to 15 parts by mass, and the amount of dinitrosopentamethylenetetramine (foaming agent) was changed to 5 parts by mass.

### [Preparation of Porous Elastic Layer Material 5]

A foamed material 5 for forming a porous elastic layer was obtained in the same manner as the foamed material 1 for forming a porous elastic layer except that the amount of NBR (NIPOL DN3335, manufactured by Zeon Corporation), the amount of epichlorohydrin (Hydrin T3106, manufactured by Zeon Corporation), and the amount of dinitrosopentamethylenetetramine (foaming agent) were changed to 7 parts by mass, 93 parts by mass, and 20 parts by mass, respectively.

### [Preparation of Solid Layer Material]

60 parts by mass of NBR (NIPOL DN3335, manufactured by Zeon Corporation), 40 parts by mass of epichlorohydrin (Hydrin T3106, manufactured by Zeon Corporation), 10 parts by mass of XFC carbon (VULCAN P, manufactured by Cabot Corporation), 10 parts by mass of calcium carbonate, 5 parts by mass of zinc oxide, 1 part by mass of stearic acid, 1 part by mass of sulfur, 2 parts by mass of benzothiazole sulfide (crosslinking accelerator) and 1 part by mass of tetramethylthiuram monosulfide (crosslinking accelerator) were kneaded in a kneader and then further kneaded using a roll to prepare a material for forming a solid layer.

### [Preparation of Surface Layer Material]

A surface layer forming material was prepared by mixing 100 parts by mass of a urethane-based polymer (UW-1005E, manufactured by UW-UBE Industries, Ltd) and 50 parts by mass of a polyethylene terephthalate-particle dispersion liquid (PORFLON PTFE D-310, manufactured by Daikin Industries, Ltd) using a planetary centrifugal mixer.

### [Preparation of Secondary Transfer Roller 1]

### (Preparation of Porous Elastic Layer Roller 1)

The above-described foamed material 1 for forming a porous elastic layer was coextruded onto the outer circumference of a mandrel (metal shaft) having an outside 14 mm, and the extrudate was wound around the mandrel to form the foamed material 1 into a predetermined-length tube shape. This molded article was heated in a vapor tank at 160° C. for 30 minutes to foam and vulcanized. The foamed material 1 in the form of a tube from which the mandrel had been removed was cut into a length corresponding to the dimension of the secondary transfer roller to prepare a porous elastic tube. This porous elastic tube was press-fitted onto a shaft to obtain a porous elastic layer roller 1.

The elastic layer of the porous elastic layer roller 1 had a storage elastic modulus of 100000 Pa.

The tube of the elastic layer of the porous elastic layer roller 1 was cut along the axial direction, and the outermost surface resistance was measured with the outer side of the elastic layer facing upward, and the measured outermost surface resistance was 1.0×10⁹Ω/□.

### (Preparation of Base Roller 1)

Separately, on the outer periphery of a mandrel (metal shaft) having a predetermined diameter, materials for forming solid layers were simultaneously extruded and wound around the mandrel to be formed into a tubular shape having a predetermined length. This molded product was vulcanized by heating for 160° C. for 30 minutes in a vapor tank. Next, the mandrel was extracted and cut into a length corresponding to the dimension of the roller to obtain a solid layer tube. Air was blown into the inside of the solid layer tube, and the solid layer tube was fitted to the outside of the porous elastic layer roller 1 while expanding the diameter. Thereafter, the surface of the solid layer tube was finish-polished to obtain a base roller 1 having a porous elastic layer/solid layer.

### (Preparation of Secondary Transfer Roller 1)

After removing rubber residues and dust adhering to the surfaces of the base roller 1 during polishing, the material for forming the surface layer was applied onto the outer circumferential surface of the solid layer by spraying such that the mass of the coating layer would be 0.15 g after baking, and heated at 140° C. for 30 minutes to cure, thereby forming the surface layer. Thus, a secondary transfer roller 1 including the porous elastic layer/solid layer/surface layer on the outer circumference of the shaft was obtained.

The secondary transfer roller 1 had an axial dimension of 344 mm, an outer diameter of about 24 mm, a solid layer thickness of 1.5 mm, and an outermost surface resistance of 2×10¹¹Ω/□.

### [Preparation of Secondary Transfer Roller 2]

### (Preparation of Porous Elastic Layer Roller 2)

A porous elastic layer roller 2 was obtained in the same manner as in the case of the porous elastic layer roller 1 described above except that the foamed material 1 for forming a porous elastic layer was changed to the foamed material 2 for forming a porous elastic layer. The elastic layer of the porous elastic layer roller 2 had a storage elastic modulus of 160000 Pa.

### (Preparation of Base Roller 2)

For the porous elastic layer roller 2, a solid layer tube was prepared in the same manner as in the production of the base roller 1 described above, thus obtaining a base roller 2.

### (Preparation of Secondary Transfer Roller 2)

For the base roller 2, a secondary transfer roller 2 was obtained in the same manner as in secondary transfer roller 1 described above except that the coating amount was adjusted to 0.35 g. The secondary transfer roller 2 had an outermost surface resistance of 1×10¹³Ω/□.

### [Preparation of Secondary Transfer Rollers 3 and 4]

A porous elastic layer roller 3 and a porous elastic layer roller 4 were obtained in the same manner as in the porous elastic layer roller 2 described above except that the foamed material 2 for forming a porous elastic layer was changed to the foamed material 3 or the foamed material 4 for forming a porous elastic layer. The elastic layer of the porous elastic layer roller 3 had a storage elastic modulus of 270000 Pa. The elastic layer of the porous elastic layer roller 4 had a storage elastic modulus of 300000 Pa.

Furthermore, for the porous elastic layer roller 3 and the porous elastic layer roller 4, the secondary transfer roller 3 and the secondary transfer roller 4 were obtained in the same manner as in the preparation of the base roller 2 and the secondary transfer roller 2.

### [Preparation of Secondary Transfer Roller 5]

### (Preparation of Porous Elastic Layer Roller 5)

A porous elastic layer roller 5 was obtained in the same manner as in the case of the porous elastic layer roller 1 described above except that the foamed material 1 for forming a porous elastic layer was changed to the foamed material 5 for forming a porous elastic layer. The elastic layer of the porous elastic layer roller 5 had a storage elastic modulus of 80000 Pa.

### (Preparation of Base Roller 5)

For the porous elastic layer roller 5, a solid layer tube was prepared in the same manner as the production of the base roller 1 described above, and a base roller 5 was obtained.

### (Preparation of Secondary Transfer Roller 5)

A secondary transfer roller 5 was obtained in the same manner as in the secondary transfer roller 1 except that the coating amount was adjusted to 0.6 g relative to the base roller 5. The secondary transfer roller 5 had an outermost surface resistance of 7×10¹³Ω/□.

### [Preparation of Secondary Transfer Roller 6]

A secondary transfer roller 6 was produced in the same manner as the secondary transfer roller 1 except that the coating amount was adjusted to 0.03 g relative to the base roller 5. The secondary transfer roller 6 had an outermost surface resistance of 3×10¹⁰Ω/□.

### <Intermediate Transfer Belt>

An intermediate transfer belt to be mounted on an image forming apparatus was prepared by the following method. As the intermediate transfer belt, a single-layer belt formed of only a base material layer made of polyimide (PI) and an inorganic-organic hybrid belt in which a coating layer made of an inorganic-organic hybrid material was formed on a PI base material layer were prepared.

### [Preparation of PI Single-Layer Belt]

To 100 parts by mass of “Yupia ST1001 (solids content: 18% by mass)” (manufactured by Ube Industries, Ltd), 23 parts by mass of dried oxidation-treated carbon black “Mitsubishi Carbon Black HCF #2650” (manufactured by Mitsubishi Chemical Corporation, pH3.0, volatile content: 8.0%) was added, and the mixture was dispersed using a collision-type disperser “NanoJet Pal JN100” (manufactured by Jokoh Co., Ltd). The dispersion was carried out by eight passes through the passage at a set pressure of 250 MPa and a flow rate of 100 ml per minute. Thus, a varnish 1 for base material layer was obtained.

The vanish 1 for base material layer was applied to the inner peripheral surface of a cylindrical mold to a depth of 0.5 mm using a dispenser, and the mold was rotated at a 1500 rpm for 15 minutes to form a uniformly thick spread layer of the vanish. While rotating the mold at 250 rpm, hot air having a temperature of 60° C. was blown to the mold from the outside of the mold for 30 minutes. Next, the mold was heated at 150° C. for 60 minutes. Next, the mold was heated to 360° C. at a temperature rising rate of 2° C./min, and further heated at 360° C. for 30 minutes to remove the evaporated solvent and water generated by dehydration ring closure from the spread layer and to complete the imide conversion reaction in the spread layer. Thus, an endless PI single-layer belt made of polyimide in which carbon black was dispersed was obtained.

### [Preparation of Inorganic-Organic Hybrid Belt]

On the outer surface of the PI single-layer belt prepared by the above method, an organic-inorganic hybrid material SSG-HB21BN was applied (dipping method), and then baked under an air atmosphere at 100° C. for 60 minutes to form a 1.8 μm-thick coating layer, thereby preparing a coated belt composed of a base material layer and the coating layer.

### <Counter Roller>

### [Preparation of Counter Roller 1]

A mixture of 70 parts by mass of NBR (Nipol DN401, manufactured by Zeon Corporation), 30 parts by mass of epichlorohydrin (Hydrin T3106, manufactured by Zeon Corporation), 10 parts by mass of XFC carbon (VULCAN P, manufactured by Cabot Corporation), 13 parts by mass of calcium carbonate, 5 parts by mass of zinc oxide, 1 part by mass of stearic acid, 10 parts by mass of process oil (Diana Process PW380, manufactured by Idemitsu Petrochemical Co., Ltd), 1 part by mass of sulfur, 2 parts by mass of dibenzothiazole sulfide (crosslinking accelerator) and 1 part by mass of tetramethylthiuram monosulfide (crosslinking accelerator) was kneaded, co-extruded onto the outer circumference of a core metal having an outside 14 mm, and then placed in a vapor tank at 160° C. for 30 minutes for vulcanization.

After the vulcanization, the surfaces were finish-polished, and furthermore, after rubber residues and dust were removed, the above-described materials for forming the surface layer were applied onto the outer peripheral surface by a spray method so that the weight of the coating layer would be 0.12 g after baking, and heated at 100° C. for 30 minutes to cure, thereby forming the surface layer. Thus, a counter roller 1 was obtained. The length of the counter roller 1 in the axial direction was 344 mm, the outer diameter was 24 mm, and the hardness was 70°.

### [Production of Counter Roller 2]

A counter roller 2 was obtained in the same manner as the counter roller 1, except that the amount of NBR (NIPOL DN401 manufactured by Zeon Corporation) was changed to 60 parts by mass, the amount of epichlorohydrin (Hydrin T3106 manufactured by Zeon Corporation) was changed to 40 parts by mass, the amount of XFC carbon (VULCAN P manufactured by Cabot Corporation) was changed to 15 parts by mass, and the amount of calcium carbonate was changed to 5 parts by mass. The hardness of the counter roller 2 was 55°.

### <Image Forming Tests 1 to 9>

Tests 1 to 9 were performed using combinations of the toners, the secondary transfer rollers, the intermediate transfer belts, and the counter rollers shown in Table 1 below.

A toner cartridge was filled with each of the toners (1) to (3), and a developing machine was filled with each of the developers (1) to (3).

In addition, in the tests, an image forming apparatus (manufactured by Konica Minolta Inc., AccurioLabel230, Japan) modified so that system speed is 650 mm/s, and fixing temperature can be changed in a range of 80° C. to 200° C. was used. The secondary transfer roller, the intermediate transfer belt, and the counter roller that were described above were attached to the modified machine, and then the prepared toner cartridge and developing machine were installed at the cyan position, and this was set as an image forming apparatus for evaluation.

### <Evaluation>

The following evaluations were performed in Tests 1 to 9. The evaluation results are listed in Table 1 below. Those which passed the following evaluation criteria in both the total image quality evaluation and the heat resistance evaluation were regarded to be acceptable in the overall evaluations.

### [Image Quality: Total Image Quality]

The rank of the worse of the transfer evaluation and the fixing evaluation of the image quality evaluation was adopted as the evaluation of the total image quality.

In the present tests, A was the best evaluation, D was the worst evaluation, and those with the evaluations of “A”, “B”, and “C” were determined to be acceptable.

### [Image Quality: Transfer]

A cyan halftone image was printed continuously under 1500 m conditions on film paper WH BOPP TC2. 3M for labels (manufactured by Bridgestone Corporation) installed in an image forming apparatus for evaluation, under adjusted developing conditions in a high-temperature, high-humidity environment (a temperature of 30° C. and a humidity of 80% RH). The image density was measured at 10 points in a range of 0.5 m for each 300 m from the initial stage of output using a color measurement system FD-7 (manufactured by Konica Minolta, Inc), and the difference between the maximum and minimum values of the measurement values at the 6 points of each measurement location was determined. In the present tests, the transferability was evaluated according to the criteria described below. In the present tests, A was the best evaluation and D was the worst evaluation, and the samples having the evaluation criteria of “A”, “B”, and “C” were determined to be acceptable.

### (Evaluation Criteria)

A: The difference between the maximum value and the minimum value of each measurement point is 0.02 or less.
B: The difference between the maximum value and the minimum value at each measurement point has a value exceeding 0.02 in some cases, and is 0.04 or less in all cases.
C: The difference between the maximum value and the minimum value at each measurement point has a value exceeding 0.04 in some cases, and is 0.09 or less in all cases.
D: There is a point where the difference between the maximum value and the minimum value at each measurement point is 0.09 or more.

### [Image Quality: Fixing]

Under a normal-temperature normal-humidity (NN) environment condition (temperature: 20° C., relative humidity: 50% RH), a solid image with an A4 size and a toner adhesion amount of 8 g/m² and a white solid image with a toner adhesion amount of 0 g/m² were alternately formed five times on a cast-coated TAC paper N mirror 73/P22/G7B (manufactured by Oji Tack Inc) installed in the image forming apparatus for evaluation. At this time, the temperature of the pressure roller was set to be 20° C. lower than that of the fixing roller, and the measurement was repeatedly performed while the surface temperature of the fixing roller was changed so as to increase from 80° C. to 140° C. in increments of 5° C. Five solid images at each temperature were checked, and the fixability (low-temperature fixability) of each toner was evaluated according to the following criteria from the temperature at which the image started to be fixed. In the present tests, A was the best evaluation and D was the worst evaluation, and the samples having the evaluation criteria of “A”, “B”, and “C” were determined to be acceptable.

### (Evaluation Criteria)

A: the temperature at which an image starts to be fixed is lower than 120° C.
B: the temperature at which the image starts to be fixed is 120° C. or more and less than 135° C.
C: the temperature at which an image starts to be fixed is 135° C. or more and less than 140° C.
D: the temperature at which the image starts to be fixed is 140° C. or more

### [Heat Resistance]

Toner 0.5 g was placed in a 10 mL glass bottle having an inside diameter of 21 mm, the glass bottle was closed with a lid, and the glass bottle was shaken 600 times at room temperature with Tap Denser KYT 2000 (manufactured by Seishin Enterprise Co., Ltd). Thereafter, in a state where the lid was removed, the resultant was left under environments at three levels of temperature of 57.5° C., 60.0° C., and 62.5° C. and 35% RH for 2 hours. Next, the toner was placed on a 48-mesh sieve (opening: 350 μm) while taking care not to crush toner aggregates, and the sieve was set in a powder tester (manufactured by Hosokawa Micron Corporation) and fixed with a pressing bar and a knob nut. After vibration was applied for 10 seconds by adjusting the vibration intensity of the feed 1 mm, the ratio (% by mass) of the toner remaining on the sieve was measured.

Furthermore, a toner aggregation rate was calculated by the following expression.

[toner aggregation rate (%)=remaining toner mass on sieve(g)/0.5(g)×100]

The toner aggregation rate was measured at the three levels of temperature, the temperature at which the aggregation rate reached 50% was estimated, and this temperature was regarded as a 50% aggregation temperature. In the present tests, the heat-resistant storage property (50% aggregation temperature) of the toner was evaluated according to the evaluation criteria described below. A was the best evaluation, D was the worst evaluation, and the toners having the evaluation criteria of “A” and “B” were regarded to be acceptable.

### (Evaluation Criteria)

A: 50% aggregation temperature is 62° C. or higher (heat-resistant storage property of toner is extremely good)
B: a 50% aggregation temperature of 60° C. or more and less than 62° C. (heat-resistant storage property of the toner is good)
C: 50% Aggregation temperature of 57.5° C. or more and less than 60° C. (allowable level, though slightly inferior in heat-resistant storage property of toner)
D: 50% Aggregation temperature is less than 57.5° C. (heat-resistant storage property of toner is poor and unusable)

TABLE 1

| | | | Test 1 | Test 2 | Test 3 | Test 4 | Test 5 |
|---|---|---|---|---|---|---|---|
| Configuration | Toner | | Amorphous Pes/ | St - Ac/ | St - Ac/ | Amorphous Pes/ | Amorphous Pes/ |
| | | | Crystalline Pes | Amorphous Pes/ | Amorphous Pes/ | Crystalline Pes | Crystalline Pes/ |
| | | | | Crystalline Pes | Crystalline Pes | | |
| | Secondary | Configuration | Porous | Porous | Porous | Porous | Porous |
| | transfer | | elastic layer/ | elastic layer/ | elastic layer/ | elastic layer/ | elastic layer/ |
| | roller | | Solid layer/ | Solid layer/ | Solid layer/ | Solid layer/ | Solid layer/ |
| | | | Surface layer | Surface layer | Surface layer | Surface layer | Surface layer |
| | | Storage | 100000 | 160000 | 270000 | 160000 | 300000 |
| | | elastic | | | | | |
| | | modulus | | | | | |
| | | (Pa) | | | | | |
| | | Outermost | 2 × 10¹¹ | 1 × 10¹³ | 1 × 10¹³ | 1 × 10¹³ | 1 × 10¹³ |
| | | surface | | | | | |
| | | resistance | | | | | |
| | | (Ω/□) | | | | | |
| | Intermediate | Configuration | Inorganic | Inorganic | Inorganic | Inorganic | Inorganic |
| | transfer belt | | organic | organic | organic | organic | organic |
| | | | hybrid | hybrid | hybrid | hybrid | hybrid |
| | Counter | Hardness | 70 | 70 | 70 | 70 | 55 |
| | roller | | | | | | |
| Evaluation | Overall evaluation | | Acceptable | Acceptable | Acceptable | Acceptable | Acceptable |
| | Image | Total image | B | A | A | B | B |
| | quality | quality | | | | | |
| | | Transfer | A | A | A | A | A |
| | | Fixing | B | A | A | B | B |

| | | | | | |
|---|---|---|---|---|---|
| Heat resistance | B | A | A | B | B |

| | | | | | Test 8 | Test 9 |
|---|---|---|---|---|---|---|
| | | | Test 6 | Test 7 | (reference) | (reference) |
| Configuration | Toner | | Amorphous Pes/ | Amorphous Pes/ | Amorphous Pes | Amorphous Pes/ |
| | | | Crystalline Pes/ | Crystalline Pes/ | | Crystalline Pes |
| | Secondary | Configuration | Porous | Porous | Porous | Porous |
| | transfer | | elastic layer/ | elastic layer/ | elastic layer/ | elastic |
| | roller | | Solid layer/ | Solid layer/ | Solid layer/ | layer |
| | | | Surface layer | Surface layer | Surface layer | |
| | | Storage | 80000 | 80000 | 100000 | 100000 |
| | | elastic | | | | |
| | | modulus | | | | |
| | | (Pa) | | | | |
| | | Outermost | 7 × 10¹³ | 3 × 10¹⁰ | 2 × 10¹¹ | 1 × 10⁹ |
| | | surface | | | | |
| | | resistance | | | | |
| | | (Ω/□) | | | | |
| | Intermediate | Configuration | Inorganic | PI single | PI single | PI single |
| | transfer belt | | organic | layer | layer | layer |
| | | | hybrid | | | |
| | Counter | Hardness | 55 | 55 | 55 | 55 |
| | roller | | | | | |

| | | | | | |
|---|---|---|---|---|---|
| Evaluation | Overall evaluation | Acceptable | Acceptable | Unacceptable | Unacceptable |

| | | | | | |
|---|---|---|---|---|---|
| Image | Total image | B | C | D | D |
| quality | quality | | | | |
| | Transfer | B | C | C | D |
| | Fixing | B | B | D | B |

| | | | | |
|---|---|---|---|---|
| Heat resistance | B | B | B | B |

As shown in Table 1 above, in tests 1 to 6 in which a toner containing an amorphous polyester and a crystalline polyester, a secondary transfer roller formed of an amorphous polyester and a crystalline polyester, and an intermediate transfer belt having a coating layer of an inorganic-organic hybrid material were combined, high evaluation was obtained for both heat resistance and image quality.

In particular, in Tests 2 and 3 in which the toner containing the styrene acrylic resin and the storage elastic modulus of the secondary transfer roller was 100000 Pa or more and 275000 Pa or less, better results than those in the other tests were obtained in the evaluation of image quality.

Further, between Test 5 and Test 6 having the same configuration except for the configuration of the secondary transfer roller, Test 5 is superior in transferability. In Test 5, the outermost surface resistance of the secondary transfer roller is in a range of 5×10¹⁰Ω/□ or more and 5×10¹³Ω/□ or less, whereas in Test 6, the outermost surface resistance of the secondary transfer roller is outside of the above range. From this result, by setting the outermost surface resistance of the secondary transfer roller in the above range, the transferability of the toner image from the intermediate transfer belt to the recording material is improved, and the image quality is improved.

In addition, in Test 7 in which the intermediate transfer belt does not include a coating layer formed of an inorganic-organic hybrid material, the evaluation of the transferability is lower than that in Test 6 in which the configuration is the same except for the intermediate transfer belt. From this result, by forming an inorganic-organic hybrid material layer on the surface of the intermediate transfer belt, the transferability of the toner image from the intermediate transfer belt to the recording material is improved, and the image quality is improved.

In Test 8 using the toner (3) in which the binder resin was formed of only the amorphous polyester, the evaluation of the fixability was lower than that in Test 7 having the same configuration except for the toner. This result shows that the fixing property is improved, and the image quality is improved by including the crystalline polyester as the binder resin.

The transferability is significantly lower in Test 9 in which the secondary transfer roller is formed of a porous elastic layer alone and the intermediate transfer belt includes a Mika base material layer only than in the other tests. In Test 9, since the toner (1) containing a crystalline polyester is used, the fixing property is good. However, since the intermediate transfer belt does not have a coating layer, the transferability of the toner image from the intermediate transfer belt to the recording material is degraded. Furthermore, since the secondary transfer roller does not include a solid layer and a surface layer and has a low outermost surface resistance, a nip pressure or an electric field is less likely to be uniformly applied to the recording material, the mobility of the toner from the intermediate transfer belt to the recording material decreases, and the transferability of the toner image decreases.

It should be noted that the present invention is not limited to the configuration described in the above embodiment, and various modifications and changes can be made without departing from the configuration of the present invention.

### Reference Signs List

1 image forming apparatus, 10 sheet feed section, 11, 61 support shaft, 20 supply adjustment section, 40 image forming apparatus main body, 41 controller, 42 operation display unit, scanner section 43, 44 conveying portion, 46 image forming section, 47 fixing section, 48 storage section, 50 collection adjustment section, 60 collection section, 460 laser light, 461 exposure section, 462 photoreceptor, 463 developing section, 464 primary transfer roller, 465 intermediate transfer belt, 466 secondary transfer roller, 467 counter roller, 471 fixing roller, and 472 pressure roller.

What is claimed is:

1. An image forming method comprising:
forming a toner image on an intermediate transfer belt using a toner containing a crystalline polyester; and
holding a recording material between a secondary transfer roller and the intermediate transfer belt and transferring the toner image to the recording material by the secondary transfer roller, wherein the secondary transfer roller has a first layer that is a surface layer, a second layer that is formed of a solid layer provided on an inner peripheral side of the first layer, and a third layer that is formed of a porous elastic layer provided on an inner peripheral side of the second layer.

2. The image forming method according to claim 1, wherein the intermediate transfer belt has a coating layer containing a cured product of alkoxysilane formed on a surface thereof.

3. The image forming method according to claim 1, wherein a storage elastic modulus of the third layer formed of the porous elastic layer of the secondary transfer roller is 100000 Pa or more and 275000 Pa or less.

4. The image forming method according to claim 1, wherein a counter roller having a surface hardness equal to or greater than 65° is caused to face the secondary transfer roller via the intermediate transfer belt to transfer the toner image onto the recording material.

5. The image forming method according to claim 1, wherein an outermost surface resistance of the secondary transfer roller is 5×10¹⁰Ω/□ or more and 5×10¹³Ω/□ or less.

6. The image forming method according to claim 1, wherein the toner contains an amorphous polyester as a binder resin.

7. The image forming method according to claim 6, wherein the toner contains a styrene acrylic resin as the binder resin.

8. The image forming method according to claim 1, wherein the intermediate transfer belt is driven at a linear velocity of 250 mm/s or more and 700 mm/s or less.

9. The image forming method according to claim 1, wherein images of a plurality of pages are continuously formed on the recording material.

10. An image forming apparatus comprising:
an image forming section that forms a toner image on an intermediate transfer belt, sandwiches a recording material with the intermediate transfer belt and a secondary transfer roller, and transfers the toner image onto the recording material by the secondary transfer roller to form an image,
wherein the secondary transfer roller includes a first layer serving as a surface layer, a second layer formed of a solid layer provided on an inner peripheral side of the first layer, and a third layer formed of a porous elastic layer provided on an inner peripheral side of the second layer.

11. The image forming apparatus according to claim 10, wherein the intermediate transfer belt includes a cured product of alkoxysilane in a coating layer.

12. The image forming apparatus according to claim 10, wherein a storage elastic modulus of the third layer formed of the porous elastic layer of the secondary transfer roller is 100000 Pa or more and 275000 Pa or less.

13. The image forming apparatus according to claim 10, further comprising:
a counter roller that faces the secondary transfer roller via the intermediate transfer belt,
wherein a surface hardness of the counter roller is equal to or greater than 65°.

14. The image forming apparatus according to claim 10, wherein an outermost surface resistance of the secondary transfer roller is 5×10¹⁰Ω/□ or more and 5×10¹³Ω/□ or less.

15. The image forming apparatus according to claim 10, further comprising:
an image forming section capable of continuously forming images of a plurality of pages on the recording material
